(19) United States
(12) Patent Application Publication
(10) Pub. No.: US 2026/0148321 A1
(43) Pub. Date: May 28, 2026

(54) AUTOMATED VENDOR INVOICE DISPUTE SYSTEM

(71) Applicant: KENVUE BRANDS LLC, Summit, NJ (US)

(72) Inventors: Christopher J. Hedin, Bridgewater, NJ (US); Carolyn M. Sebastian, Summit, NJ (US); Radu - Adrian SPANTU, Cergy (FR)

(21) Appl. No.: 19/396,434

(22) Filed: Nov. 21, 2025

Related U.S. Application Data
(60) Provisional application No. 63/725,805, filed on Nov. 27, 2024.

(51) Int. Cl. G06Q 50/18; G06Q 30/04

(52) U.S. Cl. CPC G06Q 50/182; G06Q 30/04

(57) ABSTRACT

Systems, devices, and methods may be related to an automated vendor invoice dispute system. A device may include a processor. The device may be configured to retrieve invoice information from an end user database. The device may be configured to retrieve shipping data that indicates at least that the shipment of goods was delivered to the end user. The device may be configured to extract relevant information from invoice information and shipping data. The device may be configured to determine, based at least on an invoice amount and an indication that a shipment of goods was delivered to the end user, to dispute the invoice amount. The device may be configured to generate, based on the determination to dispute the invoice amount, a dispute message associated with the shipment of goods. The device may be configured to transmit the dispute message to the end user.

### CROSS-REFERENCE TO RELATED APPLICATIONS

This application claims the benefit of U.S. Provisional Patent Application No. 63/725,805, filed Nov. 27, 2024, titled AUTOMATED VENDOR INVOICE DISPUTE SYSTEM, the contents of which are hereby incorporated by reference herein.

### BACKGROUND

Traditional computer-based supply chain management systems often employ complicated and time consuming human user interfaces to properly handle system exceptions, such as dispute handling. A supply chain management system may include, for example, invoices, purchase orders, receipts, and/or the like. In such systems, a technical failing may prompt the use of human user interfaces; for example, the system may not have computer-readable access to the information necessary to properly handle the system exception. In an example, the human user may have to serve as a bridge between the traditional computer-based supply chain management system and other sources of information, including computer-based and non-computer based sources. The present application discloses technical solutions related to handling system exceptions that may improve upon traditional approaches. Such solutions may be used to dispute invoice and/or supply chain information, e.g., to reduce time and/or complexity associated with supply chain management systems.

### BRIEF SUMMARY

In some aspects, the techniques described herein relate to a system for determining an invoice dispute strategy, the system may include a memory that stores computer-executable instructions and/or a processor in communication with the memory. The computer-executable instructions, when executed by the processor, may cause the processor to: retrieve invoice information from an end user database, wherein the invoice information indicates an invoice ID, an invoice status, an invoice amount, and/or an invoice type associated with a shipment of goods to an end user; retrieve shipping data that indicates at least that the shipment of goods was delivered to the end user; extract, from the invoice information and/or the shipping data, the indication of the invoice ID, the invoice status, the invoice amount, the invoice type associated with the shipment of goods, and/or the indication that the shipment of goods was delivered to the end user; determine, based at least on the invoice amount and/or the indication that the shipment of goods was delivered to the end user, to dispute the invoice amount; generate, based on the determination to dispute the invoice amount, a dispute message associated with the shipment of goods, wherein the dispute message indicates at least the invoice ID, that the invoice type is invalid, an invoice status of disputed, and/or a disputed payment amount; and/or transmit the dispute message to the end user.

In some aspects, the techniques described herein relate to a system, wherein the computer-executable instructions, when executed, further cause the processor to: determine that a parameter associated with the invoice information or the shipping data satisfies a threshold; and/or determine to dispute the invoice amount further based on the determination that the parameter satisfies the threshold, wherein the generated dispute message further indicates a dispute justification summary, wherein the dispute justification summary includes text associated with the disputed payment amount.

In some aspects, the techniques described herein relate to a system, wherein the determination that the parameter associated with the invoice information or the shipping data satisfies the threshold is based on at least one of: a determination that a quantity of goods associated with the shipment of goods sent to the end user is not equal to a quantity of goods associated with the shipment of goods delivered to the end user, an elapsed time is greater than a threshold time, a quantity of disputed shipments exceeds a threshold quantity of shipments, the disputed payment amount exceeds a threshold dollar value, or a success rate associated with past disputed shipments is less than a threshold percentage.

In some aspects, the techniques described herein relate to a system, wherein the computer-executable instructions, when executed, further cause the processor to: format the invoice information from the end user database and/or the shipping data into a pre-defined format; and/or store the invoice information and/or the shipping data in a user accessible database, wherein the determination whether to dispute the invoice amount occurs in response to storing the invoice information and/or the shipping data in the user accessible database.

In some aspects, the techniques described herein relate to a system, wherein the computer-executable instructions, when executed further cause the processor to: compare the invoice ID with the shipping data to determine that the invoice information and/or the shipping data correspond to the shipment of goods, wherein the determination whether to dispute the invoice amount is further based on the determined correspondence.

In some aspects, the techniques described herein relate to a system, wherein the computer-executable instructions, when executed, further cause the processor to: determine that a second parameter associated with the dispute message satisfies a second dispute threshold; based on the determination that the second parameter satisfies the second dispute threshold, generate a second dispute message that indicates at least a second disputed payment amount, and/or a second dispute justification summary, wherein the second dispute justification summary includes text associated with the second disputed payment amount; and/or transmit the second dispute message to the end user.

In some aspects, the techniques described herein relate to a system, wherein the computer-executable instructions, when executed, further cause the processor to: determine that the second parameter associated with the dispute message satisfies the second dispute threshold based on at least one of: an elapsed time since the dispute message was sent is greater than a time threshold, a quantity of disputed shipments is greater than a threshold number of shipments, the second disputed payment amount greater than a threshold dollar value, or a success rate associated with past disputed shipments is less than a threshold percentage.

In some aspects, the techniques described herein relate to a system, wherein the shipping data includes at least one of a purchase order, a receipt, a proof of delivery, or an invoice, and/or wherein the dispute message transmitted to the end user is configured to improve a recovery rate associated with the disputed payment amount.

In some aspects, the techniques described herein relate to a system, wherein the indication that the invoice type is invalid further indicates that the shipment of goods is not open, short, or damaged (OS&D), and/or wherein the disputed payment amount is determined based at least on a comparison of the invoice amount to a quantity of goods delivered to the end user.

In some aspects, the techniques described herein relate to a system, wherein the determination whether to generate the dispute message is further based on a trained artificial intelligence (AI) model, wherein the trained AI model is trained via training data, wherein the training data includes historical invoice information, historical dispute messages, and/or historical shipping data.

In some aspects, the techniques described herein relate to a method for determining an invoice dispute strategy including: retrieving invoice information from an end user database, wherein the invoice information indicates an invoice ID, an invoice status, an invoice amount, and/or an invoice type associated with a shipment of goods to an end user; retrieving shipping data that indicates at least that the shipment of goods was delivered to the end user; extracting, from the invoice information and/or the shipping data, the indication of the invoice ID, the invoice status, the invoice amount, the invoice type associated with the shipment of goods, and/or the indication that the shipment of goods was delivered to the end user; determining, based at least on the invoice amount and/or the indication that the shipment of goods was delivered to the end user, to dispute the invoice amount; generating, based on the determination to dispute the invoice amount, a dispute message associated with the shipment of goods, wherein the dispute message indicates at least the invoice ID, that the invoice type is invalid, an invoice status of disputed, and/or a disputed payment amount; and/or transmitting the dispute message to the end user.

In some aspects, the techniques described herein relate to a method, wherein the method further includes: determining that a parameter associated with the invoice information or the shipping data satisfies a threshold; and/or determining to dispute the invoice amount further based on the determination that the parameter satisfies the threshold, wherein the generated dispute message further indicates a dispute justification summary, wherein the dispute justification summary includes text associated with the disputed payment amount.

In some aspects, the techniques described herein relate to a method, wherein the determination that the parameter associated with the invoice information or the shipping data satisfies the threshold is based on at least one of: a determination that a quantity of goods associated with the shipment of goods sent to the end user is not equal to a quantity of goods associated with the shipment of goods delivered to the end user, an elapsed time is greater than a threshold time, a quantity of disputed shipments exceeds a threshold quantity of shipments, the disputed payment amount exceeds a threshold dollar value, or a success rate associated with past disputed shipments is less than a threshold percentage.

In some aspects, the techniques described herein relate to a method, wherein the method further includes: formatting the invoice information from the end user database and/or the shipping data into a pre-defined format; and/or storing the invoice information and/or the shipping data in a user accessible database, wherein the determination whether to dispute the invoice amount occurs in response to storing the invoice information and/or the shipping data in the user accessible database.

In some aspects, the techniques described herein relate to a method, wherein the method further includes: comparing the invoice ID with the shipping data to determine that the invoice information and/or the shipping data correspond to the shipment of goods, wherein the determination whether to dispute the invoice amount is further based on the determined correspondence.

In some aspects, the techniques described herein relate to a method, wherein the method further includes: determining that a second parameter associated with the dispute message satisfies a second dispute threshold; based on the determination that the second parameter satisfies the second dispute threshold, generating a second dispute message that indicates at least a second disputed payment amount, and/or a second dispute justification summary, wherein the second dispute justification summary includes text associated with the second disputed payment amount; and/or transmitting the second dispute message to the end user.

In some aspects, the techniques described herein relate to a method, wherein the method further includes: determining that the second parameter associated with the dispute message satisfies the second dispute threshold based on at least one of: an elapsed time since the dispute message was sent is greater than a time threshold, a quantity of disputed shipments is greater than a threshold number of shipments, the second disputed payment amount greater than a threshold dollar value, or a success rate associated with past disputed shipments is less than a threshold percentage.

In some aspects, the techniques described herein relate to a method, wherein the shipping data includes at least one of a purchase order, a receipt, a proof of delivery, or an invoice, and/or wherein the dispute message transmitted to the end user is configured to improve a recovery rate associated with the disputed payment amount.

In some aspects, the techniques described herein relate to a method, wherein the indication that the invoice type is invalid further indicates that the shipment of goods is not OS&D, and/or wherein the disputed payment amount is determined based at least on a comparison of the invoice amount to a quantity of goods delivered to the end user.

In some aspects, the techniques described herein relate to a method, wherein the determination whether to generate the dispute message is further based on a trained AI model, wherein the trained AI model is trained via training data, wherein the training data includes historical invoice information, historical dispute messages, and/or historical shipping data.

Systems, methods, and instrumentalities are disclosed associated with an automated vendor invoice dispute system. In examples, a system for determining an invoice dispute strategy may include a processor and/or memory. The system may include computer-executable instructions that, when executed by the processor, cause the processor to retrieve invoice information from a vendor (e.g., a customer, client, buyer, purchaser, end user, consumer, and/or the like) database. The invoice information may include an invoice ID, an invoice status, and/or an invoice type associated with a shipping case. The shipping case (e.g., interchangeably referred to herein as a case, a matter, a claim, an issue, a subject, an instance, an inquiry, and/or the like) may be associated with a shipment of goods from a supplier to an end user. The system may retrieve shipping data associated with the shipping case. The shipping data may include at least one indication that the shipment of the goods was delivered to the end user. The system may determine, based on the invoice information and the shipping data, whether to generate dispute data associated with the shipping case. The dispute data may include an indication of the invoice ID, an indication that the invoice type of over, short, or damaged (OS&D) for the shipping case is invalid, an indication that the invoice status is disputed, and/or an indication of a disputed payment amount. The system may estimate, based on the dispute data and the shipping data, a second payment amount that is greater than the indication of the disputed payment amount. The system may generate a dispute message. The dispute message may include the dispute data and the shipping data. The system may transmit the dispute message to the end user.

In examples, the computer-executable instructions, when executed, may further cause the system to determine that a parameter associated with the dispute data satisfies a second dispute threshold (e.g., a re-dispute threshold). The system may, based on the determination that the parameter satisfies the second dispute threshold, transmit a second dispute message to the end user. The second dispute message may include the dispute data and an indication of a second disputed payment amount.

In examples, the computer-executable instructions, when executed, may further cause the system to determine that the parameter associated with the dispute data satisfies the second dispute threshold if at least one of: an elapsed time since the dispute message was sent is greater than a threshold, a quantity of disputed cases (e.g., where a disputed case may include a dispute associated with a shipping case, claim, issue, subject, instance, inquiry, and/or the like) is greater than a threshold, a dispute amount associated with one or more disputed cases is greater than a threshold, and/or a success rate for the disputed cases is below a threshold. The system may determine whether to generate the dispute data further based on a query of the invoice information.

The query may identify the shipping case based on the invoice status indicating that the case is not disputed. The system may determine whether to generate the dispute data further based on a determination that a quantity shipped, a quantity received, and a quantity disputed are not equal. The processor may determine whether to generate the dispute data further based on a user input. The shipping data may include at least one of a purchase order, a receipt, a proof of delivery, or an invoice. The system may determine whether to generate the dispute data further based on a trained artificial intelligence (AI) model, wherein the trained AI model is trained via training data, wherein the training data comprises historical invoice information, historical dispute data, historical shipping data, and one or more previous determinations by the processor to generate the dispute data.

A method may include retrieving invoice information from an end user database. The invoice information may include an invoice ID, an invoice status, and an invoice type associated with a shipping case. The shipping case may be associated with a shipment of goods from a supplier to an end user. The method may include retrieving shipping data associated with the shipping case. The shipping data may include at least one indication that the shipment of the goods was delivered to the end user. The method may include determining, based on the invoice information and the shipping data, whether to generate dispute data associated with the shipping case. The dispute data may include an indication of the invoice ID, an indication that the invoice type of OS&D for the shipping case is invalid, an indication that the invoice status is disputed, and/or an indication of a disputed payment amount. The method may include estimating, based on the dispute data and the shipping data, a second payment amount that is greater than the indication of the disputed payment amount. The method may include generating a dispute message. The dispute message may include the dispute data and the shipping data. The method may include transmitting the dispute message to the end user.

In examples, a non-transitory, computer-readable medium may include computer-executable instructions for determining an invoice dispute strategy, wherein the computer-executable instructions, when executed by a computer system, cause the computer system to execute one or more steps of a method as described herein. A computer-implemented method for determining an invoice dispute strategy may be performed according to a method as described herein.

### BRIEF DESCRIPTION OF THE DRAWINGS

The following detailed description will be better understood when read in conjunction with the appended drawings, in which there are shown examples of one or more of the multiple embodiments of the present disclosure. It should be understood, however, that the embodiments described herein are not limited to the precise arrangements and instrumentalities shown in the drawings.

FIG. 1 illustrates an example computing environment including a supply chain management system.

FIG. 2 illustrates an example flow diagram for determining invoice dispute data and/or sending a dispute message.

FIG. 3 illustrates an example flow diagram for determining if/whether to transmit invoice second dispute message.

FIG. 4A-4E are example flow diagrams illustrating aspects associated with determining invoice dispute data and/or invoice second dispute data.

FIGS. 4F-4H depict example user interfaces for displaying invoice information, shipping information and/or dispute information.

FIG. 5 is a block diagram of an example computing system consistent with various implementations of the present disclosure.

### DETAILED DESCRIPTION

In describing the various embodiments of the present disclosure, certain terminology is used herein for convenience only and should not be considered as limiting such embodiments. In the drawings, the same reference numerals are employed for designating the same elements throughout the several figures and the present description.

### Overview

Millions of shipments of goods are received and processed by large warehouse distribution centers (e.g., interchangeably referred to herein as vendors, customers, clients, buyers, purchasers, end users, consumers, and/or the like) every day. Vendors may receive a shipment in several different ways. For example, a vendor may receive a shipment once the goods reach the vendor's warehouse dock (e.g., direct delivery), once a delivery vehicle possess the goods from the supplier, and/or once a supplier delivers goods to a third party. The shipment of goods may be accompanied by a packing list and/or a purchase order, identifying, among other things, the quantity of goods included in the shipment, the cost per unit, a total cost per shipment, the time a shipment was sent and/or received, and/or the like.

When a vendor receives a shipment, the vendor verifies the quantity and quality of goods against the packing list. Occasionally, a shipment of goods may not meet the criteria associated with a packing list, if for example, a vendor receives goods that are over, short, and/or damaged (OS&D), or if there is a receiving error. As referenced herein, a receiving error may occur even if/when a shipment is correct and/or complete (e.g., the quantity and delivery criteria matches the invoice). A receiving error may occur if the vendor (e.g., recipient, client, customer, and/or the like) of the shipment cannot accurately reconcile the shipment. In examples, a receiving error may occur if an employee and/or receiving system, at a point of receipt (e.g., a dock, a truck, a vendor location, and/or the like), inaccurately counts and/or identifies received item(s). A vendor may indicate the OS&D goods on an invoice, determine a reduced price for the OS&D goods, and/or reject the shipment (e.g., partially or altogether).

In response, a supplier may review the invoice information labeled as OS&D, accept a reduced payment, and/or dispute the vendor's invoice. In some scenarios, a received shipment may be marked OS&D erroneously (e.g., incorrectly) by a vendor. A shipment marked OS&D may indicate one or more inconsistencies associated with an invoice, an order, and/or a receipt (e.g., a three-way match does not exist based on a cost, a quantity of items, a date/time, and/or the like, associated with the invoice, order, and receipt). The shipment may be marked OS&D incorrectly due to human error, for example, if a vendor unknowingly damaged the goods or if a shipment was incorrectly counted at the warehouse. In examples, a vendor seeking to reduce costs may not conduct sufficient diligence and/or take responsibility to determine the root cause of each OS&D shipment, and thus, simply label the shipment as OS&D and reduce the payment, thereby shifting the burden to the supplier to correct the error in order for the supplier to receive full payment.

A supplier may lose millions of dollars per year in revenue if erroneous OS&D shipments are not disputed. Since a supplier is typically responsible for identifying shipments that are incorrectly labeled and invoiced as OS&D, suppliers must employ large teams to dispute and/or eventually resolve OS&D shipments. For example, a supplier may access a database and identify each OS&D invoice (e.g., interchangeably referred to herein as OS&D shipment), then retrieve and review evidence associated with shipping documents (e.g., which may be received from multiple different warehouses associated with one or both of the customer and the supplier, and may be represented in different data elements and structures across multiple customers), to determine whether an OS&D invoice is erroneous. The supplier may then open a case to dispute each erroneously labeled shipment. Additionally, the supplier may be burdened with maintaining a database of unresolved OS&D cases.

Although suppliers may employ large teams to correct disputes, the sheer quantity of invoices and/or nuances associated with aggregating and analyzing invoice data from several vendor database's presents a technical problem that significantly burdens suppliers, making it impractical and impossible to retrieve, manage, and/or accurately resolve thousands (e.g., in some cases millions) of disputed invoices that are received and stored as unstructured data in data storage systems. For example, determining that a shipment labeled as OS&D is erroneous may require the supplier to query and analyze thousands of pages of shipping data (e.g., purchase orders, packing lists, and/or the like) to determine whether a quality received by the vendor matches a quantity shipped by the supplier. A supplier may be required to perform some investigative work to determine whether the supplier or the vendor is responsible for the damaged goods, for example, when goods are damaged during transit.

With hundreds of thousands (e.g., sometime millions) of transactions occurring daily between a vendor and a supplier, this places a heavy financial burden on suppliers to identify, manage, and resolve disputed invoice amounts from erroneous OS&D invoices. Using typical methods, a supplier may expect a recovery rate of only about 34% of all disputed OS&D invoices (e.g., an amount deducted per shipment versus a resolved and/or agreed amount paid per shipment).

Accordingly, the present disclosure provides a technical solution to this inherently technical problem by rapidly identifying erroneous OS&D invoice information, generating dispute data (e.g., including creating a disputed case for the shipment), maintaining and tracking disputed cases, determining a strategy for recovering lost revenue, and/or generating notifications and/or messages to a vendor indicating an incorrect invoice amount may be described herein. For example, a supply chain management system (e.g., hereinafter a system) may retrieve invoice information from an end user database, including retrieving an invoice ID, an invoice type associated with a shipping case, and/or an invoice status. The system may retrieve shipping data including an indication that a shipment of goods was delivered to the end user. The system may determine, based on the invoice information and the shipping data, whether to generate dispute data associated with the shipping case. The dispute data may include an indication that the invoice type of OS&D is invalid, an indication that the invoice status is disputed, and/or an indication of a disputed payment amount. The system may estimate, based on the dispute data and the shipping data, a second payment amount that is greater than the indication the disputed payment amount (e.g., based on a determined strategy). In examples, the system may estimate the second payment amount based on the output of an artificial intelligence (AI) model. The system may generate a dispute message including dispute data as described herein and the shipping data, and/or transmit the dispute message to the end user.

The system may automatically maintain, and/or resolve OS&D invoices to improve invoice payment turn-around time, decrease supplier workload, increase the amount paid per disputed case (e.g., a yield), remove human error by eliminating one or more manual tasks, and/or reduce the number of aging cases by one of more features described herein.

Additionally, the system may monitor the resolved and/or unresolved cases and determine whether to adjust a second dispute routine (e.g., to optimize the yield) based on one or more parameters associated with a case, such as a yield, the number of aging of deductions, a quantity of disputed goods, a disputed amount, and/or the like. Using a system to resolve disputed cases, a user may expect a recovery rate of 67% of all disputed cases.

### Example Operating Environment for a Vendor Dispute Analysis System

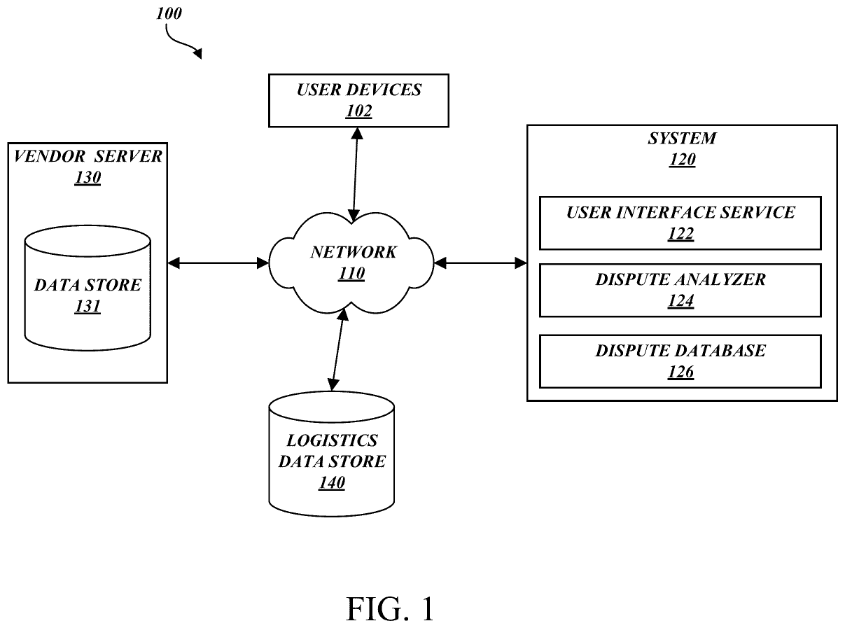

FIG. 1 illustrates an example computing environment 100 for a supply chain management system 120. The computing environment 100 may include user devices 102, a system 120, a vendor server 130, a logistics data store 140, and/or a network 110. In examples, a system 120 may receive (e.g., via network 110) invoice information from a vendor server 130. The invoice information may be used by the system 120 to determine whether an OS&D invoice exists, whether to generate a dispute message in response to an OS&D invoice, and/or whether to generate an email notification including an OS&D invoice among other actions. The system 120 may store information associated with an OS&D invoice in a logistics data store 140 and/or store information internally via dispute database 126. In examples, a user device 102 may receive one or more notifications associated with the an OS&D invoice from the system 120, from a vendor server 130, and/or from a logistics data store 140.

A system 120 may include a user interface service 122, a dispute analyzer 124, and/or dispute database 126.

A user interface service 122 may generate and/or provide one or more dispute messages to a user device 102, to a vendor server 130, and/or the like. A user interface service 122 may provide a user (e.g., via user device 102) with the means to view invoice information, dispute data, shipping data, training data, a dispute message, and/or the like. The user interface service 122 may receive a user input (e.g., via user device 102). The user input may, for example, enable and/or disable a second dispute routine, provide the system 120 with a threshold associated with an invoice dispute routine and/or a second dispute routine, and/or provide the system 120 with data associated with invoice information, dispute data, shipping data, training data and/or a dispute message. In examples, a user interface service 122 may display a number of disputed cases (e.g., a total number of disputed cases) associated with a vendor server 130. In examples, a user interface service 122 may receive training data. Training data may be used by the system 120 to train an artificial intelligence/machine learning model (AI model) to identify erroneous invoice information (e.g., based on shipping data and/or the like) including an invoice type of OS&D as described herein.

A dispute analyzer 124 may receive data (e.g., invoice information, shipping information, dispute data, and/or the like) from a user interface service 122 and/or user devices 102 (e.g., via a user input), and/or from vendor server 130, logistics data store 140, and/or dispute database 126. In examples, dispute analyzer 124 may receive data (e.g., including invoice information, shipping information, dispute data, and/or the like) via an email, a text message, a phone call, a video call, a fax, an instant message, a file-sharing platform, a push notification, and/or the like (e.g., from a user interface service 122 and/or user devices 102). A dispute analyzer 124 may determine whether to generate and/or transmit a dispute message to a vendor server 130 based on the received data, and/or based on a user input via user interface service 122 and/or user devices 102. For example, in response to a user input, the dispute analyzer 124 may request access to data store 131 via a request message. A request message may include one or more credentials of the system 120, a two-step verification process, and/or the like. The dispute analyzer 124 may request invoice information associated with a shipment of goods from the vendor server 130. The dispute analyzer 124 may receive invoice information for a shipment and/or for a plurality of shipments.

For a shipment, the dispute analyzer 124 may determine an invoice number (e.g., interchangeably referred to herein as an invoice ID) and/or an invoice type (e.g., an OS&D invoice type). The dispute analyzer 124 may, for the shipment, determine an invoice status (e.g., not disputed, disputed, resolved, paid, unpaid, and/or the like). The dispute analyzer 124 may retrieve shipping data from logistics data store 140, from a user device 102, from data store 131, and/or from dispute database 126 based on invoice information. In examples, if the dispute analyzer 124 determines that an invoice type is OS&D and/or an invoice status is not disputed for an associated invoice number, the dispute analyzer 124 may retrieve shipping data associated with the invoice number. The dispute analyzer 124 may determine, based on the shipping data, whether to generate a dispute message (e.g., including dispute data) for the shipment indicating an invoice type of OS&D. In examples, the dispute analyzer 124 may predict whether a shipment may be associated with an incorrectly labeled invoice type (e.g., OS&D), due to a receiving error, an issue with reading an advanced shipping notification (ASN), via a blind receipt process, and/or the like. Dispute analyzer 124 may compare one or more parameters associated with the shipping data to the invoice information, to determine if an invoice type is improperly labeled as OS&D. For example, the dispute analyzer 124 may determine, based on shipping data, that an amount of goods received equals the number of goods shipped and/or the like.

Shipping data may be generated by the dispute analyzer 124, a user (e.g., user device 102), and/or retrieved from a vendor server 130 and/or logistics data store 140. Shipping data may be based on the shipment and delivery of goods from a supplier to a vendor and/or third party. Shipping data my provide information regarding the status, quality, quantity, timing of delivery, liable party, and/or the like associated with a shipment of goods. In examples, shipping data may include information associated with a purchase order, a packing list, a receipt, a proof of delivery (POD), an image of received goods, tracking information, inventory data (e.g., a quantity of SKU numbers, SKU numbers, serial numbers, and/or the like), a BOL, a sales order, a delivery note, and/or the like.

If the dispute analyzer 124 determines that a shipment of goods includes an invoice type (e.g., OS&D) that is erroneous (e.g., based on the shipping data), the dispute analyzer 124 may generate dispute data. Dispute data may include information associated with the disputed shipment of goods. Dispute data may be sent by the dispute analyzer 124 via a dispute message to the vendor server 130 to create a case against the vendor, and/or to a user device 102 (e.g., to one or more users via a distribution list). In examples, dispute data may include an invoice number, a dispute title, a dispute justification summary, contact information, supporting documents (e.g., shipping data), a disputed amount, and/or the like. Dispute data may include a table and/or list of one or more disputed shipments. In examples, a table may identify a dispute ID, a marketplace (e.g., US, UK, CA, CN, and/or the like), a dispute reason (price variance, units shipped, and/or the like), a dispute date, a dispute status (e.g., resolved, unresolved, pending vendor action, and/or the like), a total disputed amount, and/or an approved amount for one or more disputed shipments.

The dispute analyzer 124 may transmit a dispute message (e.g., including dispute data) to the vendor server 130 (e.g., via the network 110). Once the dispute analyzer 124 transmits a dispute message, the dispute analyzer 124 may transmit dispute data to dispute database 126, and/or logistics data store 140. In examples, the dispute analyzer 124 may transmit a table including information associated with dispute data, to one or more users (e.g., via user device 102).

The dispute analyzer 124 may determine whether to generate and/or transmit a second dispute message. A second dispute message may include updated information associated with dispute data. In examples, a second dispute message includes an updated dispute justification summary, one or more supporting documents (e.g., shipping data), and/or the like. A second dispute message may provide an indication (e.g., to a vendor server 130) that a disputed shipment has been pending for too long (e.g., a pending status exceeds a threshold time) and/or a request for action by the vendor.

The dispute analyzer 124 may determine whether to transmit a second dispute message to a vendor server 130 periodically, based a comparison of one or more parameters to a threshold and/or in response to a user input (e.g., via user interface service 122 and/or user devices 102 requesting to transmit a second dispute message for an associated shipment). One or more parameters may be associated with, for example, dispute data, shipping data, and/or invoice information. In examples, a second dispute message may be sent if an elapsed time has passed since a last dispute message was sent, a quantity of disputed shipments is greater than a threshold, a disputed amount associated with one or more disputed shipments is greater than a threshold, a number of shipments with the same dispute status is above a threshold (e.g., a number of unresolved shipments exceeds a threshold), an elapsed time associated with a dispute status exceeds a threshold, and/or the like.

In examples, a dispute analyzer 124 may train an AI model to identify one or more errors associated with invoice information. For example, a dispute analyzer 124 may generate training data and/or retrieve training data from dispute database 126, data store 131, and/or logistics data store 140. Training data may include shipping data (e.g., purchase orders, packing lists, and/or the like), invoice information (e.g., data associated with an erroneously marked invoice status and/or a correctly marked invoice status), dispute data, and/or any other information relevant to training the AI model. The dispute analyzer 124 may input training data into an AI model, to train the model to detect errors in invoice information such as an incorrectly labeled shipment (e.g., a shipment labeled as short, but the shipping data indicates that the goods received matches the goods shipped, and/or the like). In examples, a trained AI model may receive invoice information and/or shipping data, and automatically generate dispute data based on the received input data. As an illustrative example, an AI model may be trained to identify and/or resolve one or more errors associated with invoice information (e.g., via UiPath, solarium, MS flow, and/or the like).

Dispute analyzer 124 may train an AI-based model at least in part using RPA-gathered data (e.g., data based on cases previously executed by the system 120), to optimize repayment rates, cycle times, and/or processes by analyzing trends. In examples, the training data may be used to further optimize an AI model, to continuously improve recovery metrics as described herein.

The dispute analyzer 124 may generate and/or execute a decision matrix (e.g., a decision tree). The decision matrix may include shipping data, training, data, dispute data, and/or the like (e.g., data associated with OS&D). A dispute analyzer 124 may use a decision matrix to optimize the dispute message (e.g., to optimize the content of a dispute message), to maximize the probability and/or value associated with repayment from the vendor, and/or to prevent the system 120 from failing to complete a task (e.g., the dispute analyzer 124 may determine, based on the decision matrix, to escalate a disputed shipment by transmitting a message to a second user, to determine the terms of a settlement for a disputed shipment, and/or to alter the content of a dispute message sent to the vendor). In examples, if a repayment is not received from a vendor, the dispute analyzer 124 may update an existing decision tree using updated data from the vendor database, the first dispute message, and/or historical data from past cases, to improve the total amount recovered (e.g., the gross recovery of the deduction by the vendor may be optimized based on a determination of a time, a cost, and/or an amount to settle). The dispute analyzer 124 may randomize one or more (e.g., a group of) dispute messages such that the message includes a first group of elements (e.g., critical elements such as an invoice ID, an invoice status, and/or an invoice type associated with a shipping case). The dispute analyzer 124 may determine to exclude a second group of elements and/or generate message that is not repetitive in nature (e.g., randomized a portion of the data to avoid vendor-trigger detection techniques).

In examples, the dispute analyzer 124 may determine an optimized dispute strategy based on the invoice data, the shipping data, and/or the dispute message(s). For example, the dispute analyzer 124 may receive a response from a vendor (e.g., a response to a transmitted dispute message including an update to a case, an adjustment to a payment, an indication of a resolution (e.g., a request to settle including a settlement amount), an update to shipping data, invoice data, and/or the like), and determine if/whether to submit a second dispute message, whether to settle the disputed shipment, and/or determine information that may be associated with a dispute message (e.g., to contest the response from the vendor), to increase the likelihood of resolving the OS&D shipment (e.g., to achieve the highest payment associated with a case).

For example, a dispute analyzer 124 may analyze information associated with previous cases (e.g., historical shipment data, invoice data, and/or the like) to determine and/or generate information that provides the optimal likelihood that a vendor will agree to pay the disputed amount (e.g., a targeted settlement amount). In examples, the dispute analyzer 124 may determine an optimal amount to request, and/or critical data to include in a dispute message based on historical data associated with dispute messages, shipping data, and/or invoice data.

For example, the dispute analyzer 124 may review a requested disputed amount versus the amount a vendor paid (e.g., for a plurality of previous cases), to determine whether a dispute message should increase and/or decrease a requested amount. The dispute analyzer 124 may review historical data to determine a strategy for resolving a dispute by determining one or more patterns or trends associated with a vendor. A pattern and/or trend may indicate an average payment amount and/or percentage submitted by a vendor, an average timing for payment (e.g., an average number of days after a dispute message is sent), a determined number of goods marked OS&D by the vendor, or the average settlement amount versus a first proposed settlement amount (e.g., the amount indicated in a first dispute response versus the actual settlement amount). In examples, a strategy may indicate the type of information to include in a dispute message, the context associated with a dispute message (e.g., which may be generated based on an input into a large language model (LLM) and/or the like) and/or the timing of when to submit a dispute message to obtain the quickest response from a vendor.

A system 120 may include dispute database 126. Dispute database 126 may store dispute data, invoice information, shipping data, and/or training data as described herein. In examples, dispute analyzer 124 may store a dispute message in dispute database 126. In examples, dispute analyzer 124 may, in response to a parameter satisfying a threshold, retrieve a dispute message from dispute database 126, update the message based on dispute data, shipping data, and/or invoice information, and transmit a second dispute message to a vendor server 130.

A computing environment 100 may include a vendor server 130. The vendor server 130 may generate and/or transmit (e.g., via network 110) invoice information to the system 120, user devices 102, and/or a logistics data store 140. The vendor server 130 may store data (e.g., invoice information, shipping data, dispute data, and/or the like) in data store 131. A vendor server 130 may generate and/or update invoice information, shipping data, and/or dispute data in response to, for example, receiving a shipment of goods from a supplier, a message received from a system 120, a user input from a user device 102, and/or the like. In examples, the vendor server 130 may update an invoice status in response to a received dispute message from a system 120, and/or user devices 102. In examples, vendor server 130 may transmit data (e.g., invoice information, shipping data, dispute data, and/or the like) from data store 131 to user devices 102, the system 120, logistics data store 140, and/or the like based on a request from a dispute analyzer 124.

Invoice information may be associated with a shipment of goods (e.g., information that may describe and/or provide details and/or metrics associated with one or more shipments of goods from a supplier to a vendor). For example, invoice information for a shipment of goods may include an invoice number, an invoice type (OS&D, N/A, and/or the like), an invoice status (e.g., not disputed, disputed, resolved, paid, unpaid, and/or the like), payment information (e.g., a full amount and/or a deducted amount), a time and/or date, a vendor ID, shipping data (as described herein), a unit cost, a quantity of goods shipped, and/or a number of goods received by the vendor (e.g., if a shipment of goods is labeled as OS&D, the number of goods indicated as received by the vendor may be less than the number of goods shipped by the supplier). In examples, invoice information may indicate that the shipment includes: an invoice type of OS&D, an invoice number, a date, a dispute amount (e.g., an amount approved for payment by the vendor to the supplier that is less than the original invoice amount due to the invoice type of OS&D), and/or a total quantity of items received.

A computing environment 100 may include a logistics data store 140. A logistics data store 140 may be an external data store. Logistics data store 140 may store shipping data, dispute data, training data and/or invoice information. In examples, the system 120, user devices 102, and/or the vendor server 130 may transmit data to logistics data store 140 (e.g., based on a request from user devices 102). While the logistics data store 140 is depicted as being external to the system 120, this is not meant to be limiting. For example, the logistics data store 140 may be internal to the system 120. The logistics data store 140 may be a database residing on a user device 102 that is transmitted to the system 120 via network 110.

The computing environment 100 may include a user device 102. Users may use a user device 102 to view and/or interact with one or more graphical user interfaces (GUIs) provided by the user interface service 122. A user may use user devices 102 to generate data (e.g., shipping data, invoice information, training data, and/or dispute data). In examples, a user device 102 may transmit data to the system 120, vendor server 130, and/or logistics data store 140. For example, the user device 102 can include a wide variety of computing devices, including personal computing devices, terminal computing devices, laptop computing devices, tablet computing devices, electronic reader devices, mobile devices (e.g., desktop computer, notebook computer, smartphone, or any other type of computing device) and associated software (e.g. a browser capable of rendering output from information provided by, for example, user interface service 122, the vendor server 130, logistics data store 140, and/or the like).

A network 110 may include one or more communications networks, such as the Internet. The network 110 may be any combination of local area network (“LAN”) and/or a wireless area network (“WAN”) or the like. Accordingly, various components of the computing environment 100, including the system 120, vendor server 130, logistics data store 140, and/or the user device 102, may communicate with one another directly or indirectly via any appropriate communications links and/or networks, such as network 110 (e.g., one or more communications links, one or more computer networks, one or more wired or wireless connections, the Internet, any combination of the foregoing, and/or the like). Similarly, the various sub-components (e.g., as described herein) of the computing environment 100 may, in various examples, communicate with one another directly or indirectly via any appropriate communications links (e.g., one or more communications links, one or more computer networks, one or more wired or wireless connections, the Internet, any combination of the foregoing, and/or the like).

### Example Invoice Dispute Routine

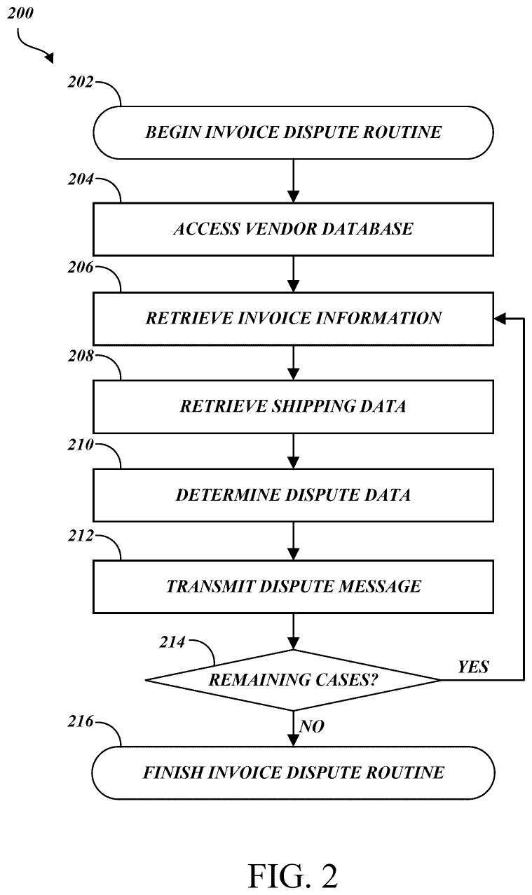

FIG. 2 is a flow chart depicting an example routine 200 for generating a dispute message that may be associated with a supply chain system 120. The routine 200 begins at block 202.

At block 204, the system 120 (e.g., dispute analyzer 124) may access a vendor database (e.g., vendor server 130, data store 131, and/or logistics data store 140). The system 120 may automatically access a vendor database upon a request via a user device 102, periodically based on set frequency as determined by a user and/or by the system 120, and/or upon a parameter satisfying a threshold (e.g., as described herein such as for example a number of shipments including a specified invoice status (e.g., not disputed) that exceeds a threshold, a disputed amount that exceeds a threshold, and/or the like).

At block 206, the system 120 may retrieve invoice information (e.g., from a vendor server 130). A system 120 may transmit a request to a vendor server 130, to transmit invoice information to the system 120. In examples, a user device 102 may transmit a request to the vendor server 130, to transmit invoice information to the system 120. A system 120 may transmit a request for invoice information in response to a user input (e.g., via a user device 102 and/or via user interface service 122), periodically based on a frequency as provided by the system 120 and/or a user device 102, based on a parameter satisfying a threshold, and/or after receiving an indication from the vendor server 130 (e.g., an indication from the vendor server 130 that updated invoice information is available).

As described herein, invoice information may be associated with a shipment of goods. Invoice information may include an invoice number, an invoice type (OS&D, N/A, and/or the like), an invoice status (e.g., not disputed, disputed, resolved, paid, unpaid, and/or the like), payment information (e.g., a full amount and/or deducted or partial amount), a time and/or date, a vendor ID, shipping data (as described herein), a unit cost, a quantity of goods shipped, and/or a number of goods received (e.g., if a shipment of goods is labeled as OS&D, the number of goods received may be less than the number of goods shipped).

As an illustrative example, the system 120 may query invoice information from vendor server 130 and/or data store 131 for data associated with shipments that include an invoice type of OS&D and/or an invoice status of disputed and/or undisputed. The system 120 my extract invoice information (e.g., an invoice number, an invoice amount, an invoice date, a dispute status, a dispute type, a vendor ID, and/or the like) based on the query to include the information as part of dispute data.

At block 208, a system 120 may retrieve shipping data. A system 120 may retrieve shipping data from data store 131, logistics data store 140, user devices 102, and/or dispute database 126. The system 120 may retrieve shipping data in response to a user input (e.g., via user device 102 and/or user interface service 122). A system 120 may retrieve shipping data based on invoice information. In examples, the system 120 may transmit, to user devices 102, a request for shipping data in response to receiving invoice information. As an illustrative example, a system 120 may retrieve shipping data (e.g., a purchase order, a packing list, and/or the like) based on received invoice information (e.g., based on a received invoice number, invoice type, and/or invoice status). For example, the system 120 may retrieve shipping data based on invoice information indicating an invoice type, an invoice number, an invoice amount, and/or the like. In examples, the system 120 may retrieve shipping data based on a determination that invoice information indicates OS&D for a shipment. As described herein, shipping data my provide information (e.g., evidence) regarding the status, quality, quantity, timing of delivery, liable party, and/or the like, associated with a shipment of goods. In examples, shipping data may include a purchase order, a packing list, a receipt, a proof of delivery (POD), an image of received goods, tracking information, inventory data (e.g., SKU numbers, serial numbers, and/or the like), a bill of landing (BOL), a sales order, a delivery note, and/or the like.

At block 210, the system 120 may determine dispute data. The system 120 may determine the dispute data based on a determination that a shipment of goods includes an invoice type (e.g., OS&D) that is erroneous (e.g., based on a comparison of information included in, among other things, the shipping data) and/or that invoice information satisfies a threshold. The system 120 may include logic to identify a valid and/or invalid shortage of goods (e.g., determine a quantity shipped, quantity received, and/or a quantity disputed) based on the shipping data and/or the invoice information. In response to determining that invoice information is invalid and/or satisfies a threshold, the system 120 may generate the dispute data. As an illustrative example, the system 120 may generate dispute data based on a disputed amount exceeding a threshold.

Dispute data may include information associated with a disputed shipment of goods. The system 120 may send dispute data, via a message to the vendor server 130, to create a case against a vendor, and/or to a user device 102 (e.g., to one or more users via a distribution list). In examples, the system 120 may store dispute data in dispute database 126 and/or logistics data store 140 for retrieval. In examples, dispute data may include an invoice number, a dispute title, a dispute justification summary, contact information, supporting documents (e.g., shipping data), a disputed amount, and/or the like. Dispute data may include a table and/or list of one or more disputed shipments. In examples, a table may include a dispute ID, a marketplace (e.g., US, UK, CA, CN, and/or the like), a dispute reason (price variance, units shipped, and/or the like), a dispute date, a dispute status (e.g., resolved, unresolved, pending vendor action, and/or the like), a total disputed amount, and/or an approved amount for one or more shipments.

As an illustrative example, the system 120 may determine a dispute justification summary of: “No shortages were reported to the system, please repay this deduction. Thank you.” In examples, the system 120 may determine one or more dispute justification summaries based on the invoice information (e.g., whether the disputed amount is incorrect, whether the shipment was not OS&D, and/or the like). As an illustrative example, a dispute justification summary may include the following, “The shipment was delivered in full and in accordance with the purchase order. The invoiced amount is accurate and justified. Please reverse the deduction and pay the outstanding balance immediately.”

As an illustrative example, a system 120 may determine dispute data based on shipping data. A supplier may transmit a shipment of units to a vendor. The shipping data may include a packing list indicating a quantity of units shipped, a BOL confirming the shipment quantity, and a POD signed at the time of delivery. The vendor may report (e.g., via shipping data) receiving less units then the quantity shipped, and may initiate a deduction in payment based on the perceived shortfall. The system 120 may query shipping records and determine that the full quantity was loaded and delivered to the vendor, as evidenced by the packing list, BOL, POD, and/or tracking data. The system 120 may retrieve image data of the loaded goods and inventory logs confirming the shipment quantity. The system 120 may determine the dispute data that is related to the disputed shipment from, at least the packing list, BOL, POD, and/or tracking data. As part of the dispute data, the system 120 may generate a dispute justification summary indicating, based on the relevant data, that the full quantity was indeed loaded on the truck and to repay the difference indicated in the shipping data.

As an illustrative example, a system 120 may determine dispute data based on invoice data. A vendor may submit an invoice for a shipment, where the invoice indicates an invoice number, an invoice amount, and an invoice type designated as OS&D. The invoice status may be marked as “Disputed,” and payment information may indicate a reduced price. The system 120 may query invoice information stored in, for example, data store 131, to retrieve relevant invoice information, including the invoice number, invoice date, invoice type, invoice status, payment amount, dispute type, and/or vendor identifier. Based on an indicated dispute status and/or an indicated payment discrepancy, the system 120 may further query shipping data as described herein, to determine whether the invoice is accurately labeled as disputed. If the system 120 determines, based on the comparison, that the disputed shipment and the payment indicating the reduced price is erroneous, the system 120 may generate dispute data that includes, for example, one or more of an invoice number, an invoice date, an invoice type, an invoice status, a payment amount, a dispute type, a vendor identifier, and/or a dispute justification summary indicating, that the indicated reduced the payment is in error.

At block 212, the system 120 may transmit a dispute message to the vendor server 130 (e.g., via the network 110). The dispute message may include dispute data for one or more shipments. The dispute message may include an invoice number, a dispute title, a dispute justification summary, contact information, supporting documents (e.g., shipping data), a disputed amount, and/or the like. In examples, the system 120 may generate a data table including dispute data for one or more shipments. The system 120 may generate the dispute message based on dispute data included in the data table. As an illustrative example, a data table may include for example, an invoice number, a dispute ID, a dispute title, a date of a dispute message, an invoice status, a dispute amount, a shortage item count, a disputed item count, a quantity, and invoice amount, and/or the like for one or more shipments. The data table may be transmitted to one or more users (e.g., via user device 102). Once the dispute message is sent to the vendor server 130, the system 120 may store the dispute message to dispute database 126, and/or logistics data store 140 for historical records and/or as training data.

At decision node 214, the system 120 may determine whether the invoice information indicates that a second shipment is in error (e.g., includes an invoice type of OS&D and/or an invoice status of not disputed) and/or the invoice information satisfies a threshold as described herein. If the system 120 determines that another shipment includes incorrect invoice information and/or the information satisfies a threshold, the routine 200 may transition to block 206 where the system 120 may retrieve invoice information for the second shipment. The system 120 populate a data table based on an aggregation of information associated with each shipment that is determined to include an error. In examples, the system 120 may aggregate individual dispute messages for the shipments into one dispute message. If the system 120 does not identify an error in the invoice information the routine may end at block 216.

### Example Invoice Subsequent-Dispute Selector Routine

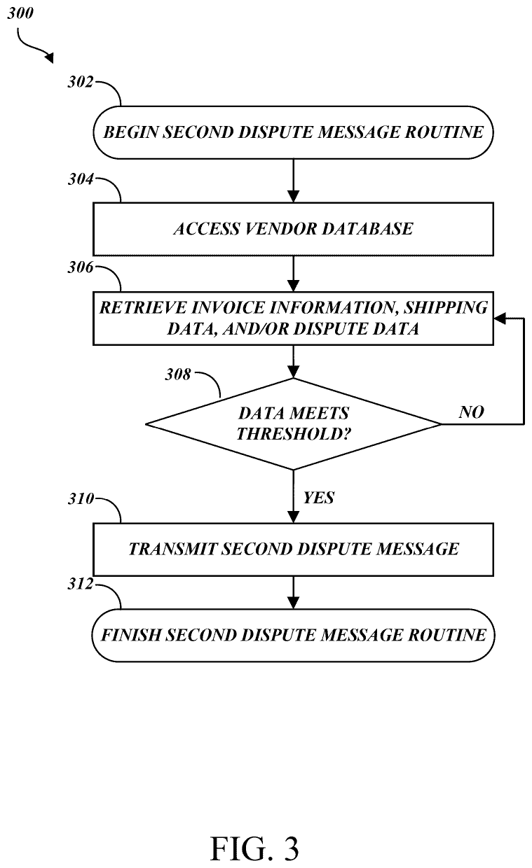

FIG. 3 is a flow chart depicting an example routine 300 for determining if/whether to transmit a second dispute message (e.g., a subsequent dispute message). The routine 300 begins at block 302.

At block 304, the system 120 (e.g., dispute analyzer 124) may access a vendor database (e.g., vendor server 130, data store 131, and/or logistics data store 140). In examples, block 304 may be the same and/or similar to block 204 of routine 200.

At block 306, the system 120 may retrieve invoice information, shipping data, and/or dispute data. Data may be retrieved from data store 131, logistics data store 140, dispute database 126, user devices 102, and/or the like. As an illustrative example, the system 120 may query invoice information for one or more shipments that include an invoice type of disputed, and/or a dispute status of pending vendor action. For example, the system 120 may be configured to transmit a dispute message for shipments that have been pending a vendor action for 1 week, two weeks, three weeks, and/or another threshold time as determined by a user and/or the system 120. In examples, shipping data may be updated periodically by the system 120, a user, and/or a vendor, and thus, the system 120 may retrieve shipping data as well as retrieve invoice information periodically and/or based on an indicated update.

At decision node 308, a system 120 may determine whether to transmit a second dispute message to a vendor server 130 based on a comparison of data (e.g., a comparison of one or more parameters such as a yield, the number of aging of deductions, a quantity of disputed goods, a disputed amount, and/or the like) to a threshold. A system 120 may determine whether to transmit a second dispute message to a vendor server 130 in response to a user input (e.g., via user interface service 122 and/or user devices 102 requesting to transmit a second dispute message for an associated shipment). One or more parameters may be associated with, for example, dispute data, shipping data, and/or invoice information of block 306. A threshold may be determined by the system 120 and/or received via a user input (e.g., via user devices 102 and/or user interface service 122). As an illustrative example, a second dispute message may be sent if an elapsed time has passed since a last dispute message was sent, a quantity of disputed shipments is greater than a threshold, a disputed amount associated with one or more disputed shipments is greater than a threshold, a number of shipments with the same dispute status is above a threshold (e.g., a number of unresolved shipments exceeds a threshold), an elapsed time associated with a dispute status exceeds a threshold, and/or the like. If the system 120 determines that the data satisfies a threshold, the routine proceeds to block 310. If the system 120 determines that the data does not meet a threshold, then the routine 300 may loop back to 306 where the system 120 may retrieve data (e.g., retrieve updated data periodically, based on a user input, and/or the like) to determine whether to transmit a second dispute message.

At block 310, the system 120 transmits a second dispute message (e.g., a re-dispute message) to the vendor server 130. A second dispute message may include updated information associated with dispute data. In examples, a second dispute message includes an updated dispute justification summary, one or more supporting documents (e.g., shipping data), and/or the like. A second dispute message may provide an indication (e.g., to a vendor server 130) that a disputed shipment has been pending longer than a threshold time and/or a request for action by the vendor. Additionally and/or alternatively, the system 120 may transmit, to user devices 102, a table including the invoice status, invoice number, invoice type, and/or the like, for one or more shipments associated with a second dispute message. Once the system 120 transmits the second dispute message the routine 300 ends at block 312.

### Example Aspects of an Invoice Dispute Method

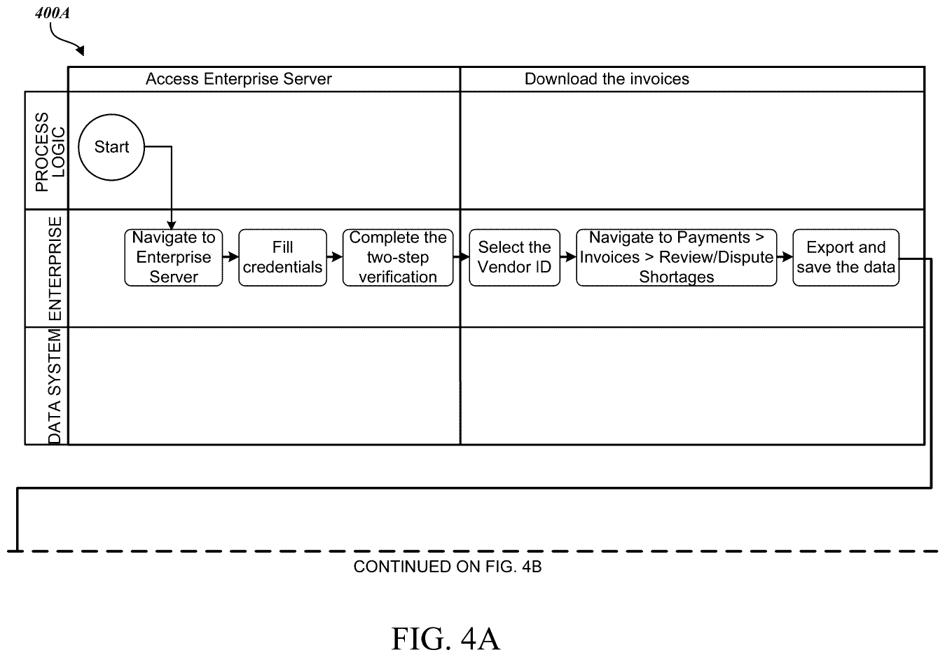

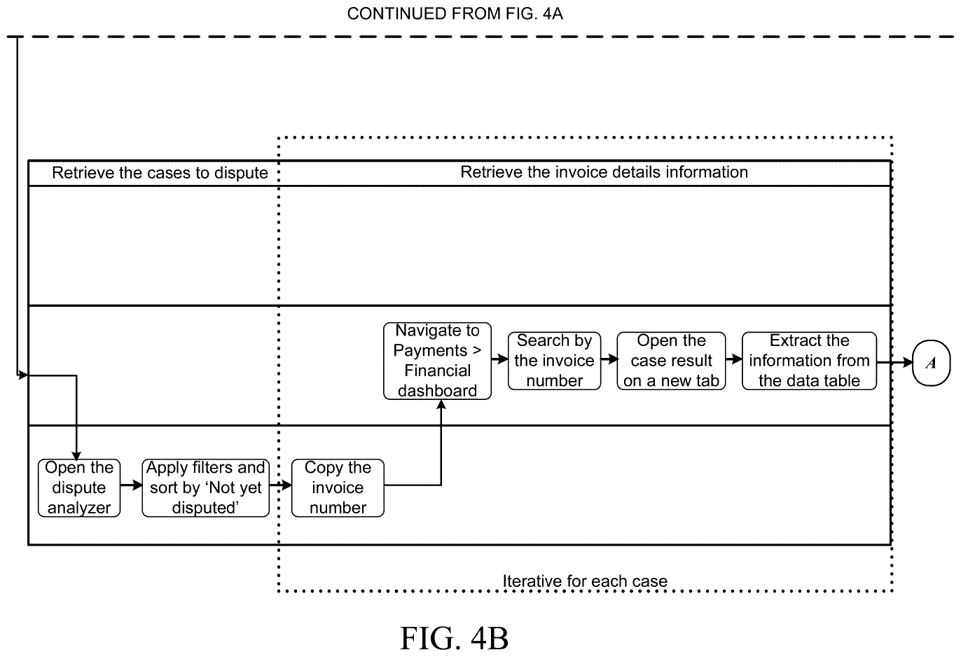

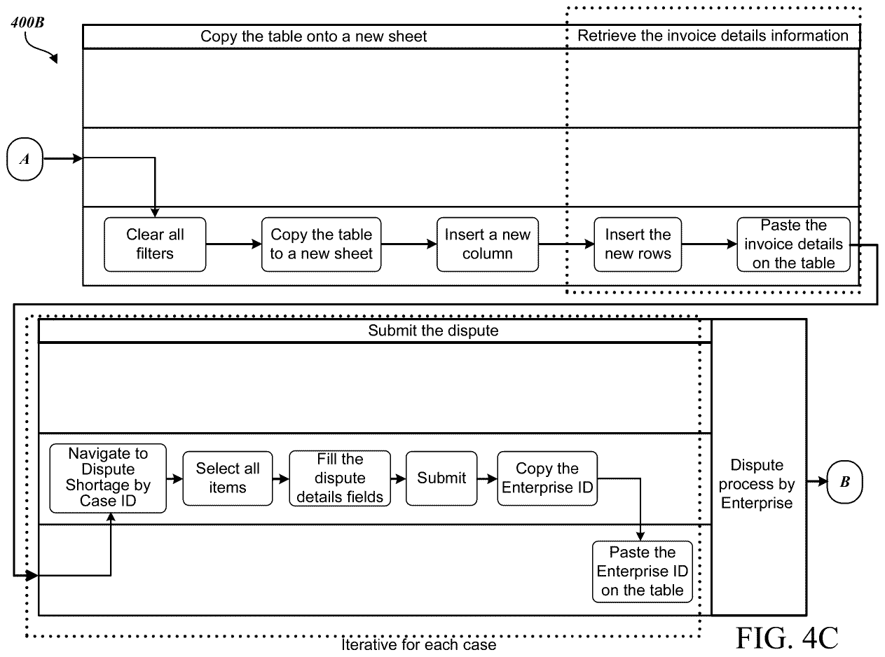

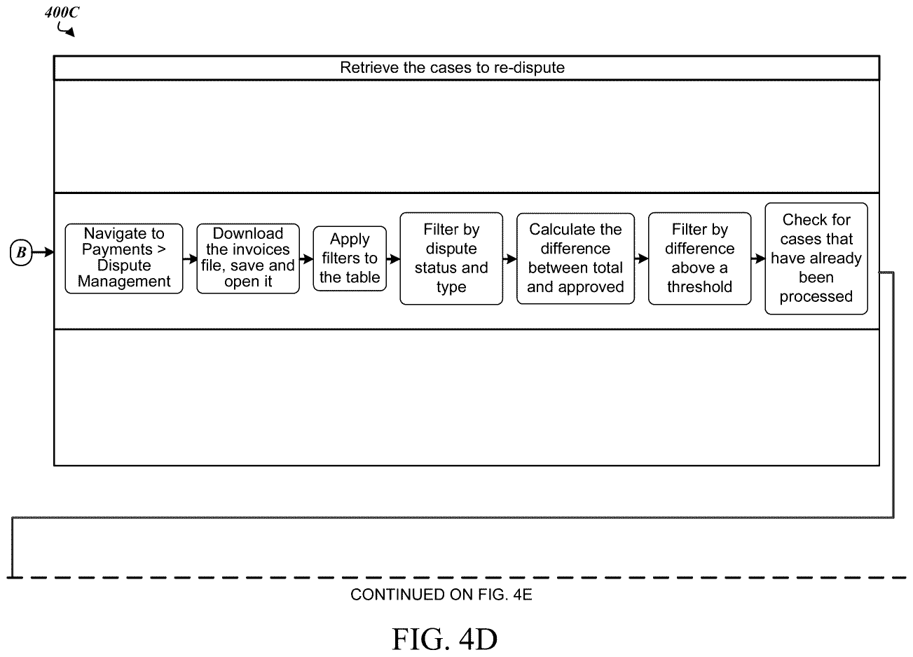

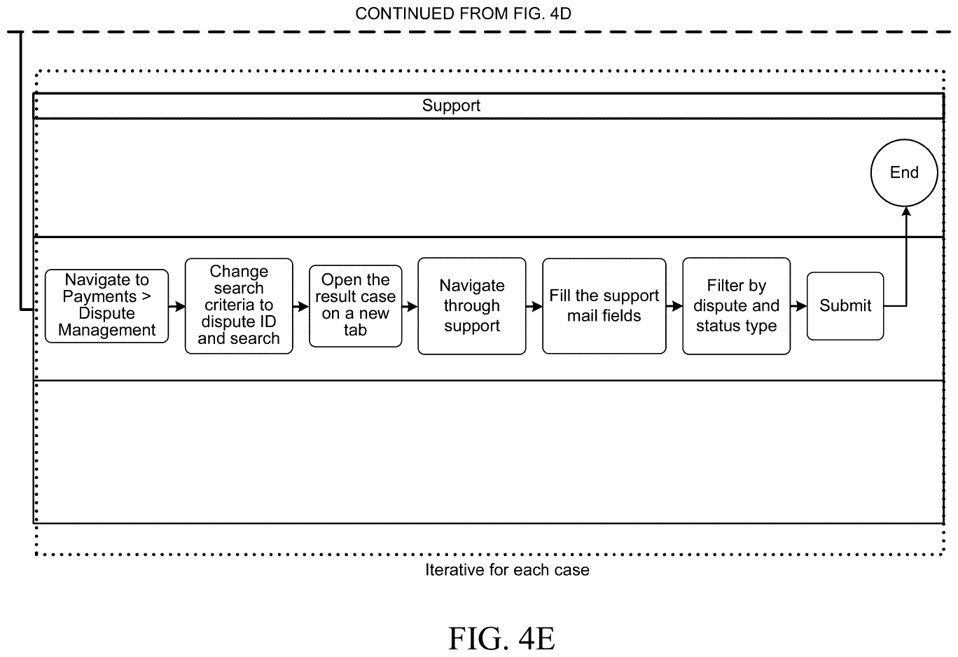

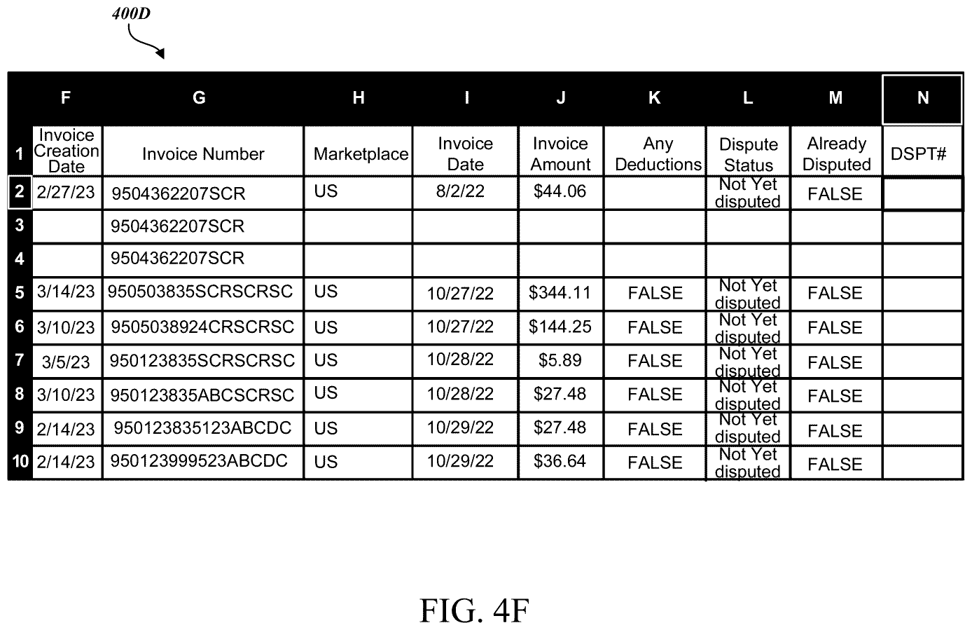

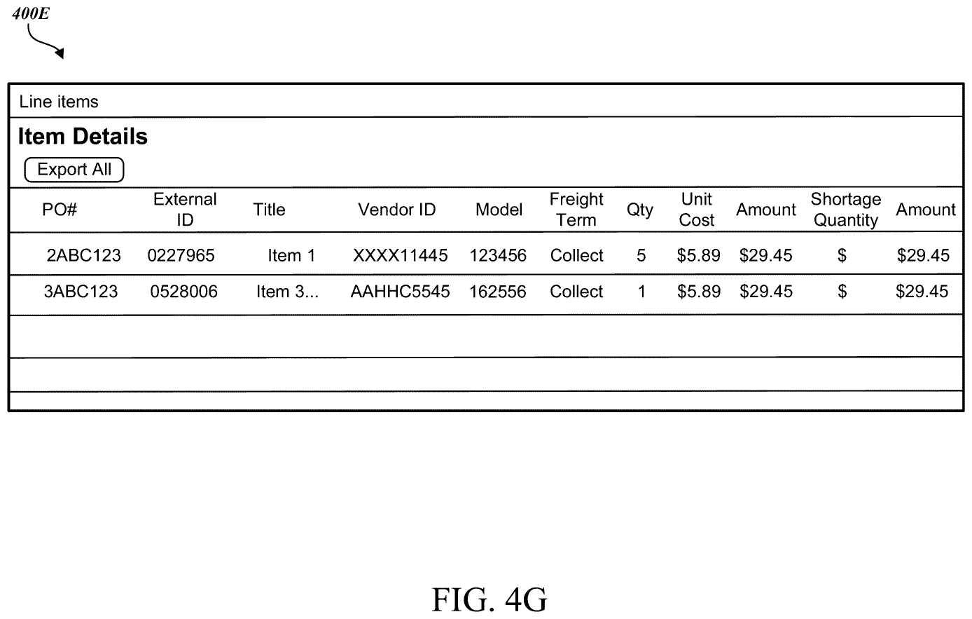

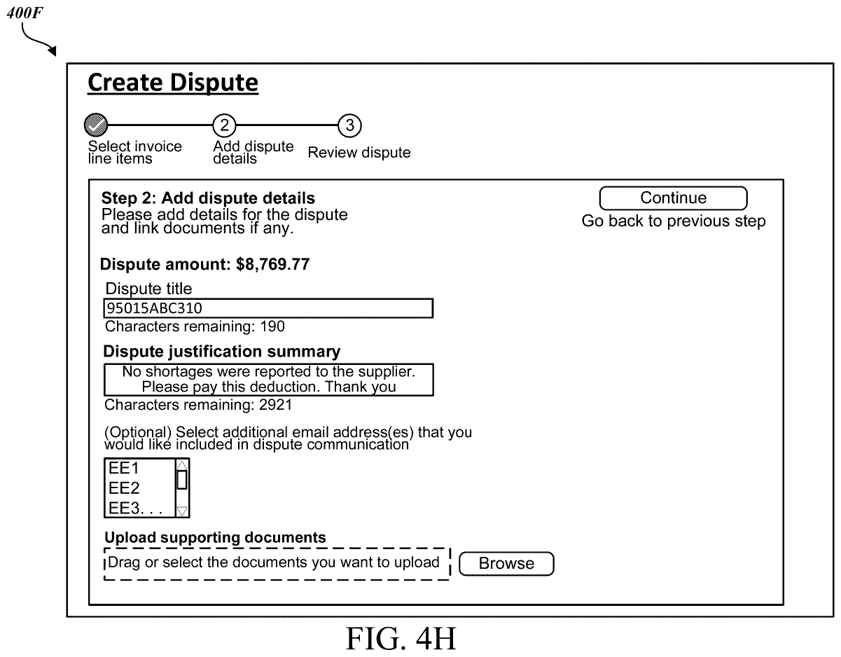

FIGS. 4A-4E are example flow diagrams 400A-400C, illustrating one or more aspects associated with determining invoice dispute data and/or invoice second dispute data. The diagrams 400A-400C illustrate an example method including one or more associated actions by the system 120 (e.g., data system) and/or a vendor server 130 (e.g., enterprise). One or more actions (e.g., automated actions, such as mimicking mouse clicks to access a vendor server 130) associated with the method may be executed automatically by the system 120 and/or in response to a user input (e.g., via user devices 102) as described herein. FIGS. 4A-4E provide an example of a system 120 that may automatically navigate to an enterprise interface (e.g., vendor server 130), retrieve invoice and/or shipping data, and generate dispute data that would otherwise require manual intervention.

Advantageously, FIGS. 4A-4E describe one or more operations that may be executed by a system 120 to merge automatic actions with a dispute algorithm to automate determining invoice dispute data. The automatic actions may be configured to mimic a user interaction with a user interface (e.g., similar to mimicking screen clicks on a user interface via a tool such as UiPath and/or the like).

For example, a system 120 may analyze the data, determine whether to initiate a dispute (e.g., whether to generate dispute data including a disputed amount, text including a dispute justification summary, and/or other information related to the disputed amount), initiate a dispute message, and store and/or maintain a database of dispute data. By integrating both a tool to automatically access vendor server 130 (e.g., via mimicking clicks on a user device) with an algorithm (e.g., to determine dispute data), a system 120 may efficiently process thousands of invoices, rapidly identify cases for dispute, and submit timely dispute messages with minimal user oversight. In comparison, manual review of thousands of invoices is impractical for such large volumes of invoices and prone to error. A recovery rate metric (e.g., the number of cases where a recovery is received, the amount recovered per case disputed, a backlog of identified cases to be disputed, and/or the like) is greatly improved when a system 120 implements automation (e.g., such as a tool that automatically mimics screen clicks, such as UiPath and/or the like) and algorithms as described herein.

The real-time use of an automated operation(s) (e.g., via a tool such as UiPath) in combination with an algorithm as described herein provides a technical improvement to invoice dispute processing by addressing practical challenges in supply chain management. For example, the system 120 can, (e.g., based on an automated tool mimicking clicks and a dispute algorithm), automatically log into a vendor portal (e.g., vendor server 130), extract invoice data, and/or submit disputes (e.g., one at a time or in bulk) to enable real-time dispute resolution and/or improved recovery rates. In examples, the system 120 may retrieve invoice information and/or shipping data by accessing a server. The server may be accessed based on operations that mimic user interactions (e.g., the vendor server 130 may be accessed by implementing actions that automatically mimic clicks on a user interface that displays a vendor portal). The system 120 may analyze the retrieved data using an algorithm (e.g., a dispute determination algorithm) as described herein. The system 120 may generate and/or transmit a dispute message for each invoice meeting the dispute criteria.

As illustrated in 400A, a system 120 may access an enterprise server. A system 120 may navigate to an enterprise server (e.g., vendor server 130), enter credentials, and/or complete a two-step verification process (e.g., by mimicking clicks on a user interface).

The system 120 may download the invoices (e.g., invoice information). In examples, the system 120 may select the vendor ID, navigate to payments, then to invoices, then to review/dispute shortages. The system 120 may export and/or save the data (e.g., export and save the invoice information).

The system 120 may retrieve the cases to dispute. For example, the system 120 may open the dispute analyzer (e.g., dispute analyzer 124), apply one or more filters, and/or sort the invoice information by an invoice status (e.g., not yet disputed).

Next, the system 120 may retrieve the invoice details information for a case. Retrieving the invoice details information may be an iterative process executed one or more times per invoice (e.g., invoice details information may be retrieved for each invoice). In examples, the system 120 may copy the invoice number, navigate to payments, then to a financial dashboard. The system 120 may search by the invoice number, open the case result on a new tab, and/or extract the information from the data table. In examples, the dispute process may continue to A (e.g., 400B of FIG. 4C).

Continuing to A (e.g., 400B), the system 120 may copy the table onto a new sheet. For example, the system 120 may clear one or more filters of the data table, copy the table to a new sheet, and/or insert a new column into the data table. The system 120 may format the data (e.g., the shipping data and/or the invoice information) into a pre-defined format and/or a user-defined format.

Advantageously, altering the data (e.g., obtained from the vendor server 130, logistics data store 140, and/or dispute database 126) into a standardized format (e.g., a consistent format across data systems) ensures that the system 120 is able to rapidly determine whether to generate dispute data in a consistent and predictable manner. For example, data may be formatted differently based on each individual data location (e.g., the vendor server 130, logistics data store 140, and/or dispute database 126). Formatted data may enable the system 120 to rapidly analyze thousands of invoices to quickly identify and prioritize erroneously marked invoices (e.g., invoices marked as OS&D), determine discrepancies in invoice amounts and actual goods shipped, compute a disputed invoice amount, and maintain a database of outstanding disputed invoices to improve recovery rates for disputed invoice amounts that would otherwise be forgotten or unmanageable by a user.

The system 120 may format the data by normalizing data. As an illustrative example, the system 120 may normalize data by converting monetary values (e.g., obtained from the invoice information and/or the like) to a consistent currency. The system 120 may convert disparate time and date formats to a single format.

The system 120 may format data by aggregating the data. As an illustrative example, the system 120 may aggregate data by grouping invoices by vendor, by dispute type, and/or by status. The system 120 may aggregate invoice totals for each vendor to identify patterns. In examples, the system 120 may identify a pattern such as a high dispute ratio for a vendor, a settlement amount for a vendor, or a time until settlement with a vendor.

The system 120 may conditionally format the data. As an illustrative example, the system 120 may include a visual indicator for invoice information and/or shipping data that indicates, to a user, the criticality of a disputed case (e.g., via colors, fonts, highlights, and/or the like). The visual indicator may be applied based on, for example, a time limit exceeding a threshold, a disputed amount exceeding a threshold, and/or the like. The system 120 may flag and/or indicate whether data is inconsistent and/or missing between databases, and/or indicate whether data is validated between databases.

The system 120 may format the data by sorting and/or ranking the data. As an illustrative example, the system 120 may rank the invoice cases from largest amount discrepancies first, oldest disputed cases first, and/or the like. The system 120 may rank vendors from most likely to settle to least likely to settle.

Advantageously, formatting the data provides a technical solution that ensures erroneously marked OS&D invoice information is rapidly identified, disputed, and managed in a consistent and predictable manner, that can be employed across an organization to automatically and rapidly improve invoice recovery rates. As an illustrative example, the system 120 may format the data to improve invoice recovery rates by converting monetary values into a single currency to enable rapid prioritization of dispute cases by disputed amount. The system 120 may aggregate disputed amounts by a vendor into a consolidated report to determine a total amount disputed per vendor. The system 120 may apply conditional formatting to highlight dispute cases that include validated information across multiple databases, to identify cases that can be resolved quickly without requiring additional evidence. The system 120 may rank these validated cases by their pending time since initiation, enabling the prioritization of older disputes to improve recovery rates.

The system 120 may store the formatted data (e.g., in logistics data store 140 for example) before determining whether to generate dispute data. In examples, the system 120 may store the invoice information and the shipping data in a user-accessible database. In examples, the system 120 may determine whether to dispute the invoice amount in response to storing the invoice information and the shipping data in the user-accessible database.

Next, the system 120 may retrieve the invoice details information. In examples, retrieving the invoice details information may be an iterative process executed one or more times per invoice (e.g., invoice details information may be retrieved for each invoice). In examples, the system 120 may insert the new rows into the table, and/or paste the invoice details into the table.

Next, the system 120 may submit the dispute. Submitting the dispute may be an iterative process executed one or more times per invoice (e.g., one dispute message is sent per invoice, or one dispute message may be sent for several invoices). In examples the system 120 may navigate to dispute shortage by case ID, select one or more items, fill the dispute details fields as described herein, submit the dispute, copy the enterprise ID, and/or paste the enterprise ID into the data table. In examples, the method according to 400A-400C may end with the dispute process now waiting for a response by the enterprise. In examples, the dispute process may continue to B (e.g., 400C of FIG. 4D).

Continuing to B (e.g., 400C), the system 120 may retrieve the cases to send a second dispute message (e.g., as described herein). In examples, the system 120 may navigate to payments, then to dispute management. The system 120 may download the invoices file then save and/or open the file. The system 120 may apply filters to the table. In examples, the system 120 may filter by dispute status and/or type (e.g., as described herein). The system 120 may calculate the difference between a total and/or an approved amount, filter by difference above and/or below a threshold, and/or check for cases that have already been processed.

In examples, the system 120 may execute a support step. A support step may be an iterative process executed one or more times per invoice (e.g., one support step per invoice). In examples, the system 120 may navigate to payments, then to dispute management. The system 120 may change a search criteria to dispute ID and perform a search. The system 120 may open the resulting cases on a new tab, navigate through support, fill the support mail fields, filter by dispute status and/or type, and submit a dispute (e.g., submit one dispute per invoice). After the system 120 submits the support message (e.g., dispute message), the method of 400A to 400C may end.

### Example Graphical User Interfaces for an Invoice Dispute System

FIGS. 4F-4H illustrate example graphical user interfaces and/or example data that may be generated as part of a supply chain management system 120. In examples, a user interface service 122, a user device 102, dispute analyzer 124, vendor server 130, and/or logistics data store 140 may generate, store, and/or display data as described herein.

FIGS. 4F-4G illustrate a table 400D, and 400E respectively. Tables 400D, 400E may include example invoice information. The invoice information may be retrieved from, for example, vendor server 130, data store 131, logistics data store 140, and/or dispute database 126. In examples, tables 400D, 400E may be generated as described with reference to block 206 and/or block 210 of routine 200, and/or block 306 of routine 300. As illustrated, table 400D includes data for one or more shipments. For example, the table 400D includes an invoice creation date, an invoice number, a marketplace, an invoice date, an invoice amount, any deductions, a dispute status, whether the shipment is already disputed, and/or a dispute number (e.g., DSPT#). Table 400E includes item details such as a purchase order number (PO#), an external ID, a title, a vendor ID, a model number, a freight term, a first quantity, a unit cost, an amount associated with a quantity, a shortage quantity, and/or an amount associated with the shortage quantity.

FIG. 4H illustrates an example user interface 400F including dispute data. In examples, user interface 400F may be generated by a system 120 and/or via a user input as described herein. Dispute data illustrated in user interface 400F may be generated and/or described with reference to block 210, and/or 212 of routine 200, and/or block 306, and/or 310 of routine 300. The example user interface 400F may be provided by the system 120, the vendor server 130, and/or the like. As illustrated in the example user interface 400F, dispute data may include a disputed amount, a title (e.g., an invoice number), a dispute justification summary, whether to transmit a dispute message to one or more employees, and/or a means of uploading supporting documents (e.g., shipping data, invoice information, other dispute data, and/or the like). The dispute justification may include information based on shipping data and/or invoice information as described herein. The dispute justification summary indicates that “No shortages were reported to the supplier. Please pay this deduction. Thank you.” In examples, this dispute justification summary may be include as a result of the dispute analyzer 124 determining, based on shipping data, that a quantity of goods shipped by the supplier equals the quantity of goods received by the vendor, and/or the like.

### Additional Example Implementations and Details

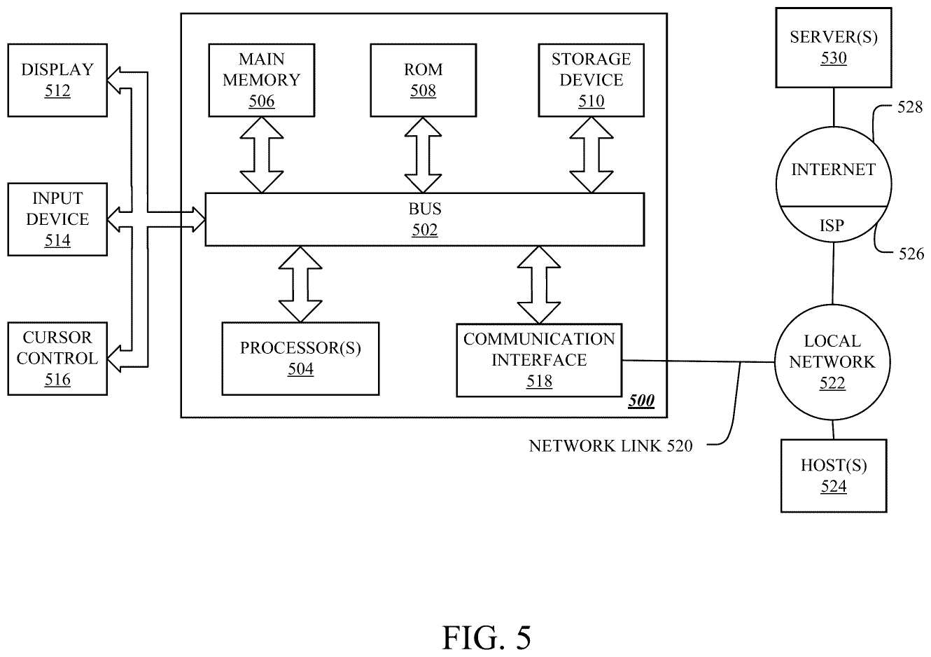

In an implementation the system (e.g., one or more aspects of the system 120, one or more aspects of the computing environment 100, 500, and/or the like) may comprise, or be implemented in, a “virtual computing environment”. As used herein, the term “virtual computing environment” should be construed broadly to include, for example, computer-readable program instructions executed by one or more processors (e.g., as described in the example of FIG. 5) to implement one or more aspects of the modules and/or functionality described herein. Further, in this implementation, one or more services/modules/engines and/or the like of the system 120 may be understood as comprising one or more rules engines of the virtual computing environment that, in response to inputs received by the virtual computing environment, execute rules and/or other program instructions to modify operation of the virtual computing environment. For example, a request received from a user computing device may be understood as modifying operation of the virtual computing environment to cause the request access to a resource from the system. Such functionality may comprise a modification of the operation of the virtual computing environment in response to inputs and according to various rules. Other functionality implemented by the virtual computing environment (as described throughout this disclosure) may further comprise modifications of the operation of the virtual computing environment, for example, the operation of the virtual computing environment may change depending on the information gathered by the system. Initial operation of the virtual computing environment may be understood as an establishment of the virtual computing environment. In some implementations the virtual computing environment may comprise one or more virtual machines, containers, and/or other types of emulations of computing systems or environments. In some implementations the virtual computing environment may comprise a hosted computing environment that includes a collection of physical computing resources that may be remotely accessible and may be rapidly provisioned as needed (commonly referred to as “cloud” computing environment).

Implementing one or more aspects of the system as a virtual computing environment may advantageously enable executing different aspects or modules of the system on different computing devices or processors, which may increase the scalability of the system. Implementing one or more aspects of the system as a virtual computing environment may further advantageously enable sandboxing various aspects, data, or services/modules of the system from one another, which may increase security of the system by preventing, e.g., malicious intrusion into the system from spreading. Implementing one or more aspects of the system as a virtual computing environment may further advantageously enable parallel execution of various aspects or modules of the system, which may increase the scalability of the system. Implementing one or more aspects of the system as a virtual computing environment may further advantageously enable rapid provisioning (or de-provisioning) of computing resources to the system, which may increase scalability of the system by, e.g., expanding computing resources available to the system or duplicating operation of the system on multiple computing resources. For example, the system may be used by thousands, hundreds of thousands, or even millions of users simultaneously, and many megabytes, gigabytes, or terabytes (or more) of data may be transferred or processed by the system, and scalability of the system may enable such operation in an efficient and/or uninterrupted manner.

Various implementations of the present disclosure may be a system, a method, and/or a computer program product at any possible technical detail level of integration. The computer program product may include a computer-readable storage medium (or mediums) having computer-readable program instructions thereon for causing a processor to carry out aspects of the present disclosure.

For example, the functionality described herein may be performed as software instructions are executed by, and/or in response to software instructions being executed by, one or more hardware processors and/or any other suitable computing devices. The software instructions and/or other executable code may be read from a computer-readable storage medium (or mediums). Computer-readable storage mediums may also be referred to herein as computer-readable storage or computer-readable storage devices.

The computer-readable storage medium can be a tangible device that can retain and store data and/or instructions for use by an instruction execution device. The computer-readable storage medium may be, for example, but is not limited to, an electronic storage device (including any volatile and/or non-volatile electronic storage devices), a magnetic storage device, an optical storage device, an electromagnetic storage device, a semiconductor storage device, or any suitable combination of the foregoing. A non-exhaustive list of more specific examples of the computer-readable storage medium includes the following: a portable computer diskette, a hard disk, a solid state drive, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer-readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer-readable program instructions described herein can be downloaded to respective computing/processing devices from a computer-readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers, and/or edge servers. A network adapter card or network interface in each computing/processing device receives computer-readable program instructions from the network and forwards the computer-readable program instructions for storage in a computer-readable storage medium within the respective computing/processing device.

Computer-readable program instructions (as also referred to herein as, for example, “code,” “instructions,” “module,” “application,” “software application,” “service,” and/or the like) for carrying out operations of the present disclosure may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. Computer-readable program instructions may be callable from other instructions or from itself, and/or may be invoked in response to detected events or interrupts. Computer-readable program instructions configured for execution on computing devices may be provided on a computer-readable storage medium, and/or as a digital download (and may be originally stored in a compressed or installable format that requires installation, decompression, or decryption prior to execution) that may then be stored on a computer-readable storage medium. Such computer-readable program instructions may be stored, partially or fully, on a memory device (e.g., a computer-readable storage medium) of the executing computing device, for execution by the computing device. The computer-readable program instructions may execute entirely on a user's computer (e.g., the executing computing device), partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some implementations, electronic circuitry including, for example, programmable logic circuitry, field-programmable gate arrays (FPGA), or programmable logic arrays (PLA) may execute the computer-readable program instructions by utilizing state information of the computer-readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to implementations of the disclosure. It will be understood that each block of the flowchart illustrations and/or block diagrams, and combinations of blocks in the flowchart illustrations and/or block diagrams, can be implemented by computer-readable program instructions.

These computer-readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer-readable program instructions may also be stored in a computer-readable storage medium that can direct a computer, a programmable data processing apparatus, and/or other devices to function in a particular manner, such that the computer-readable storage medium having instructions stored therein comprises an article of manufacture including instructions which implement aspects of the function/act specified in the flowchart(s) and/or block diagram(s) block or blocks.

The computer-readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks. For example, the instructions may initially be carried on a magnetic disk or solid-state drive of a remote computer. The remote computer may load the instructions and/or modules into its dynamic memory and send the instructions over a telephone, cable, or optical line using a modem. A modem local to a server computing system may receive the data on the telephone/cable/optical line and use a converter device including the appropriate circuitry to place the data on a bus. The bus may carry the data to a memory, from which a processor may retrieve and execute the instructions. The instructions received by the memory may optionally be stored on a storage device (e.g., a solid-state drive) either before or after execution by the computer processor.

The flowcharts and block diagrams in the Figures illustrate the architecture, functionality, and operation of possible implementations of systems, methods, and computer program products according to various implementations of the present disclosure. In this regard, each block in the flowchart or block diagrams may represent a service, module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. In addition, certain blocks may be omitted or optional in some implementations. The methods and processes described herein are also not limited to any particular sequence, and the blocks or states relating thereto can be performed in other sequences that are appropriate.

It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions. For example, any of the processes, methods, algorithms, elements, blocks, applications, or other functionality (or portions of functionality) described in the preceding sections may be embodied in, and/or fully or partially automated via, electronic hardware such application-specific processors (e.g., application-specific integrated circuits (ASICs)), programmable processors (e.g., FPGAs), application-specific circuitry, and/or the like (any of which may also combine custom hard-wired logic, logic circuits, ASICs, FPGAs, and/or the like with custom programming/execution of software instructions to accomplish the techniques).

Any of the above-mentioned processors, and/or devices incorporating any of the above-mentioned processors, may be referred to herein as, for example, “computers,” “computer devices,” “computing devices,” “hardware computing devices,” “hardware processors,” “processing units,” and/or the like. Computing devices of the above implementations may generally (but not necessarily) be controlled and/or coordinated by operating system software, such as Mac OS, iOS, Android, Chrome OS, Windows OS (e.g., Windows XP, Windows Vista, Windows 7, Windows 8, Windows 10, Windows 11, Windows Server, and/or the like), Windows CE, Unix, Linux, SunOS, Solaris, Blackberry OS, VxWorks, or other suitable operating systems. In other implementations, the computing devices may be controlled by a proprietary operating system. Conventional operating systems control and schedule computer processes for execution, perform memory management, provide file system, networking, I/O services, and provide a user interface functionality, such as a graphical user interface (“GUI”), among other things.

For example, FIG. 5 shows a block diagram that illustrates a computer system 500 upon which various implementations and/or aspects (e.g., one or more aspects of the computing environment 100, one or more aspects of the system 120, one or more aspects of the vendor server 130, one or more aspects of the logistics data store 140, one or more aspects of the user device 102, and/or the like) may be implemented. Multiple such computer systems 500 may be used in various implementations of the present disclosure. Computer system 500 includes a bus 502 or other communication mechanism for communicating information, and a hardware processor, or multiple processors, 504 coupled with bus 502 for processing information. Hardware processor 504 may be, for example, one or more general purpose microprocessors.

Computer system 500 also includes a main memory 506, such as a random-access memory (RAM), cache and/or other dynamic storage devices, coupled to bus 502 for storing information and instructions to be executed by processor 504. Main memory 506 also may be used for storing temporary variables or other intermediate information during execution of instructions to be executed by processor 504. Such instructions, when stored in storage media accessible to processor 504, render computer system 500 into a special-purpose machine that is customized to perform the operations specified in the instructions. The main memory 506 may, for example, include instructions to implement server instances, queuing modules, memory queues, storage queues, user interfaces, and/or other aspects of functionality of the present disclosure, according to various implementations.

Computer system 500 further includes a read only memory (ROM) 508 or other static storage device coupled to bus 502 for storing static information and instructions for processor 504. A storage device 510, such as a magnetic disk, optical disk, or USB thumb drive (Flash drive), and/or the like, is provided and coupled to bus 502 for storing information and instructions.

Computer system 500 may be coupled via bus 502 to a display 512, such as a cathode ray tube (CRT) or LCD display (or touch screen), for displaying information to a computer user. An input device 514, including alphanumeric and other keys, is coupled to bus 502 for communicating information and command selections to processor 504. Another type of user input device is cursor control 516, such as a mouse, a trackball, or cursor direction keys for communicating direction information and command selections to processor 504 and for controlling cursor movement on display 512. This input device typically has two degrees of freedom in two axes, a first axis (e.g., x) and a second axis (e.g., y), that allows the device to specify positions in a plane. In some implementations, the same direction information and command selections as cursor control may be implemented via receiving touches on a touch screen without a cursor.

Computer system 500 may include a user interface module to implement a GUI that may be stored in a mass storage device as computer executable program instructions that are executed by the computing device(s). Computer system 500 may further, as described below, implement the techniques described herein using customized hard-wired logic, one or more ASICs or FPGAs, firmware and/or program logic which in combination with the computer system causes or programs computer system 500 to be a special-purpose machine. According to one implementation, the techniques herein are performed by computer system 500 in response to processor 504 executing one or more sequences of one or more computer-readable program instructions contained in main memory 506. Such instructions may be read into main memory 506 from another storage medium, such as storage device 510. Execution of the sequences of instructions contained in main memory 506 causes processor 504 to perform the process steps described herein. In alternative implementations, hard-wired circuitry may be used in place of or in combination with software instructions.

Various forms of computer-readable storage media may be involved in carrying one or more sequences of one or more computer-readable program instructions to processor 504 for execution. For example, the instructions may initially be carried on a magnetic disk or solid-state drive of a remote computer. The remote computer can load the instructions into its dynamic memory and send the instructions over a telephone line using a modem. A modem local to computer system 500 can receive the data on the telephone line and use an infra-red transmitter to convert the data to an infra-red signal. An infra-red detector can receive the data carried in the infra-red signal and appropriate circuitry can place the data on bus 502. Bus 502 carries the data to main memory 506, from which processor 504 retrieves and executes the instructions. The instructions received by main memory 506 may optionally be stored on storage device 510 either before or after execution by processor 504.

Computer system 500 also includes a communication interface 518 coupled to bus 502. Communication interface 518 provides a two-way data communication coupling to a network link 520 that is connected to a local network 522. For example, communication interface 518 may be an integrated services digital network (ISDN) card, cable modem, satellite modem, or a modem to provide a data communication connection to a corresponding type of telephone line. As another example, communication interface 518 may be a local area network (LAN) card to provide a data communication connection to a compatible LAN (or WAN component to communicated with a WAN). Wireless links may also be implemented. In any such implementation, communication interface 518 sends and receives electrical, electromagnetic, or optical signals that carry digital data streams representing various types of information.

Network link 520 typically provides data communication through one or more networks to other data devices. For example, network link 520 may provide a connection through local network 522 to a host computer 524 or to data equipment operated by an Internet Service Provider (ISP) 526. ISP 526 in turn provides data communication services through the worldwide packet data communication network now commonly referred to as the “Internet” 528. Local network 522 and Internet 528 both use electrical, electromagnetic, or optical signals that carry digital data streams. The signals through the various networks and the signals on network link 520 and through communication interface 518, which carry the digital data to and from computer system 500, are example forms of transmission media.

Computer system 500 can send messages and receive data, including program code, through the network(s), network link 520 and communication interface 518. In the Internet example, a server 530 might transmit a requested code for an application program through Internet 528, ISP 526, local network 522 and communication interface 518.

The received code may be executed by processor 504 as it is received, and/or stored in storage device 510, or other non-volatile storage for later execution.

### Terminology

Processors, such as 124, 504, may be a whole or part of a computer device or system configured to implement a method, process, function, or operation of at least some of the embodiments described herein. For example, a system or methods may be implemented in the form of an apparatus that includes a processing element and a set of executable instructions. The executable instructions may be part of a software application and arranged into a software architecture.

In general, an embodiment may be implemented using a set of software instructions that are designed to be executed by a suitably programmed processing element (such as a GPU, CPU, microprocessor, processor, controller, computing device, etc.). Such instructions may be arranged into “modules” with each such module typically performing a specific task, process, function, or operation. A set of modules may be controlled or coordinated in their operation by an operating system (OS) or other form of organizational platform.

Each application module or sub-module may correspond to a particular function, method, process, or operation that is implemented by execution of the instructions contained in the module or sub-module. Such function, method, process, or operation may include those used to implement one or more aspects, techniques, components, capabilities, steps, or stages of the described system and methods. In some embodiments, a subset of the computer-executable instructions contained in one module may be implemented by a processor in a first apparatus, and a second and different subset of the instructions may be implemented by a processor in a second and different apparatus.

The application modules and/or sub-modules may include any suitable computer executable code or set of instructions (e.g., as would be executed by a suitably programmed processor, microprocessor, or CPU), such as computer-executable code corresponding to a programming language. For example, programming language source code may be compiled into computer-executable code. Alternatively, or in addition, the programming language may be an interpreted programming language such as a scripting language.

The modules may include one or more sets of instructions for performing a method or function described with reference to FIGS. 2-3, and/or 4A-4E. These modules may include those illustrated but may also include a greater number or fewer number than those illustrated. As mentioned, each module may include a set of computer-executable instructions. The set of instructions may be executed by a programmed processor contained in a system 120, as well as a server, client device, network element, system, platform, or other component. In other words, processors, 504, need not be contained by the system 120.

A module may contain computer-executable instructions that are executed by a processor contained in more than one of a server, client device, network element, system, platform or other component. Thus, in some embodiments, a plurality of electronic processors, with each being part of a separate device, server, platform, or system may be responsible for executing all or a portion of the instructions contained in a specific module.

The foregoing description, for purposes of explanation, used specific nomenclature to provide a thorough understanding of the disclosure. However, it will be apparent to one skilled in the art that the specific details are not required in order to practice the systems and methods described herein. The foregoing descriptions of specific embodiments or examples are presented by way of examples for purposes of illustration and description. They are not intended to be exhaustive of or to limit this disclosure to the precise forms described. Many modifications and variations are possible in view of the above teachings. The embodiments or examples are shown and described in order to best explain the principles of this disclosure and practical applications, to thereby enable others skilled in the art to best utilize this disclosure and various embodiments or examples with various modifications as are suited to the particular use contemplated. It is intended that the scope of this disclosure be defined by the following claims and their equivalents.

As described above, in various implementations certain functionality may be accessible by a user through a web-based viewer (such as a web browser), or other suitable software program). In such implementations, the user interface may be generated by a server computing system and transmitted to a web browser of the user (e.g., running on the user's computing system). Alternatively, data (e.g., user interface data) necessary for generating the user interface may be provided by the server computing system to the browser, where the user interface may be generated (e.g., the user interface data may be executed by a browser accessing a web service and may be configured to render the user interfaces based on the user interface data). The user may then interact with the user interface through the web-browser. User interfaces of certain implementations may be accessible through one or more dedicated software applications. In certain implementations, one or more of the computing devices and/or systems of the disclosure may include mobile computing devices, and user interfaces may be accessible through such mobile computing devices (for example, smartphones and/or tablets).

Many variations and modifications may be made to the above-described implementations, the elements of which are to be understood as being among other acceptable examples. All such modifications and variations are intended to be included herein within the scope of this disclosure. The foregoing description details certain implementations. It will be appreciated, however, that no matter how detailed the foregoing appears in text, the systems and methods can be practiced in many ways. As is also stated above, it should be noted that the use of particular terminology when describing certain features or aspects of the systems and methods should not be taken to imply that the terminology is being re-defined herein to be restricted to including any specific characteristics of the features or aspects of the systems and methods with which that terminology is associated.

Conditional language, such as, among others, “can,” “could,” “might,” or “may,” unless specifically stated otherwise, or otherwise understood within the context as used, is generally intended to convey that certain implementations include, while other implementations do not include, certain features, elements, and/or steps. Thus, such conditional language is not generally intended to imply that features, elements and/or steps are in any way required for one or more implementations or that one or more implementations necessarily include logic for deciding, with or without user input or prompting, whether these features, elements and/or steps are included or are to be performed in any particular implementation.

The term “substantially” when used in conjunction with the term “real-time” forms a phrase that will be readily understood by a person of ordinary skill in the art. For example, it is readily understood that such language will include speeds in which no or little delay or waiting is discernible, or where such delay is sufficiently short so as not to be disruptive, irritating, or otherwise vexing to a user.

Conjunctive language such as the phrase “at least one of X, Y, and Z,” or “at least one of X, Y, or Z,” unless specifically stated otherwise, is to be understood with the context as used in general to convey that an item, term, and/or the like may be either X, Y, or Z, or a combination thereof. For example, the term “or” is used in its inclusive sense (and not in its exclusive sense) so that when used, for example, to connect a list of elements, the term “or” means one, some, or all of the elements in the list. Thus, such conjunctive language is not generally intended to imply that certain implementations require at least one of X, at least one of Y, and at least one of Z to each be present.

The term “a” as used herein should be given an inclusive rather than exclusive interpretation. For example, unless specifically noted, the term “a” should not be understood to mean “exactly one” or “one and only one”; instead, the term “a” means “one or more” or “at least one,” whether used in the claims or elsewhere in the specification and regardless of uses of quantifiers such as “at least one,” “one or more,” or “a plurality” elsewhere in the claims or specification.

The term “comprising” as used herein should be given an inclusive rather than exclusive interpretation. For example, a general-purpose computer comprising one or more processors should not be interpreted as excluding other computer components, and may possibly include such components as memory, input/output devices, and/or network interfaces, among others.

While the above detailed description has shown, described, and pointed out novel features as applied to various implementations, it may be understood that various omissions, substitutions, and changes in the form and details of the devices or processes illustrated may be made without departing from the spirit of the disclosure. As may be recognized, certain implementations of the present disclosure described herein may be embodied within a form that does not provide all of the features and benefits set forth herein, as some features may be used or practiced separately from others. The scope of the present disclosure disclosed herein is indicated by the appended claims rather than by the foregoing description. All changes which come within the meaning and range of equivalency of the claims are to be embraced within their scope.

What is claimed is:

1. A system for determining an invoice dispute strategy, the system comprising:
memory that stores computer-executable instructions; and
a processor in communication with the memory, wherein the computer-executable instructions, when executed by the processor, cause the processor to:
retrieve invoice information from an end user database, wherein the invoice information indicates an invoice ID, an invoice status, an invoice amount, and an invoice type associated with a shipment of goods to an end user;
retrieve shipping data that indicates at least that the shipment of goods was delivered to the end user;
extract, from the invoice information and the shipping data, the indication of the invoice ID, the invoice status, the invoice amount, the invoice type associated with the shipment of goods, and the indication that the shipment of goods was delivered to the end user;
determine, based at least on the invoice amount and the indication that the shipment of goods was delivered to the end user, to dispute the invoice amount;
generate, based on the determination to dispute the invoice amount, a dispute message associated with the shipment of goods, wherein the dispute message indicates at least the invoice ID, that the invoice type is invalid, an invoice status of disputed, and a disputed payment amount; and
transmit the dispute message to the end user.

2. The system of claim 1, wherein the computer-executable instructions, when executed, further cause the processor to:
determine that a parameter associated with the invoice information or the shipping data satisfies a threshold; and
determine to dispute the invoice amount further based on the determination that the parameter satisfies the threshold, wherein the generated dispute message further indicates a dispute justification summary, wherein the dispute justification summary includes text associated with the disputed payment amount.

3. The system of claim 2, wherein the determination that the parameter associated with the invoice information or the shipping data satisfies the threshold is based on at least one of: a determination that a quantity of goods associated with the shipment of goods sent to the end user is not equal to a quantity of goods associated with the shipment of goods delivered to the end user, an elapsed time is greater than a threshold time, a quantity of disputed shipments exceeds a threshold quantity of shipments, the disputed payment amount exceeds a threshold dollar value, or a success rate associated with past disputed shipments is less than a threshold percentage.

4. The system of claim 1, wherein the computer-executable instructions, when executed, further cause the processor to:
format the invoice information from the end user database and the shipping data into a pre-defined format; and
store the invoice information and the shipping data in a user accessible database, wherein the determination whether to dispute the invoice amount occurs in response to storing the invoice information and the shipping data in the user accessible database.

5. The system of claim 1, wherein the computer-executable instructions, when executed further cause the processor to:
compare the invoice ID with the shipping data to determine that the invoice information and the shipping data correspond to the shipment of goods, wherein the determination whether to dispute the invoice amount is further based on the determined correspondence.

6. The system of claim 1, wherein the computer-executable instructions, when executed, further cause the processor to:
determine that a second parameter associated with the dispute message satisfies a second dispute threshold;
based on the determination that the second parameter satisfies the second dispute threshold, generate a second dispute message that indicates at least a second disputed payment amount, and a second dispute justification summary, wherein the second dispute justification summary includes text associated with the second disputed payment amount; and
transmit the second dispute message to the end user.

7. The system of claim 6, wherein the computer-executable instructions, when executed, further cause the processor to:
determine that the second parameter associated with the dispute message satisfies the second dispute threshold based on at least one of: an elapsed time since the dispute message was sent is greater than a time threshold, a quantity of disputed shipments is greater than a threshold number of shipments, the second disputed payment amount greater than a threshold dollar value, or a success rate associated with past disputed shipments is less than a threshold percentage.

8. The system of claim 1, wherein the shipping data comprises at least one of a purchase order, a receipt, a proof of delivery, or an invoice, and wherein the dispute message transmitted to the end user is configured to improve a recovery rate associated with the disputed payment amount.

9. The system of claim 1, wherein the indication that the invoice type is invalid further indicates that the shipment of goods is not open, short, or damaged (OS&D), and wherein the disputed payment amount is determined based at least on a comparison of the invoice amount to a quantity of goods delivered to the end user.

10. The system of claim 1, wherein the determination whether to generate the dispute message is further based on a trained artificial intelligence (AI) model, wherein the trained AI model is trained via training data, wherein the training data comprises historical invoice information, historical dispute messages, and historical shipping data.

11. A method for determining an invoice dispute strategy comprising:
retrieving invoice information from an end user database, wherein the invoice information indicates an invoice ID, an invoice status, an invoice amount, and an invoice type associated with a shipment of goods to an end user;
retrieving shipping data that indicates at least that the shipment of goods was delivered to the end user;
extracting, from the invoice information and the shipping data, the indication of the invoice ID, the invoice status, the invoice amount, the invoice type associated with the shipment of goods, and the indication that the shipment of goods was delivered to the end user;
determining, based at least on the invoice amount and the indication that the shipment of goods was delivered to the end user, to dispute the invoice amount;
generating, based on the determination to dispute the invoice amount, a dispute message associated with the shipment of goods, wherein the dispute message indicates at least the invoice ID, that the invoice type is invalid, an invoice status of disputed, and a disputed payment amount; and
transmitting the dispute message to the end user.

12. The method of claim 11, wherein the method further comprises:
determining that a parameter associated with the invoice information or the shipping data satisfies a threshold; and
determining to dispute the invoice amount further based on the determination that the parameter satisfies the threshold, wherein the generated dispute message further indicates a dispute justification summary, wherein the dispute justification summary includes text associated with the disputed payment amount.

13. The method of claim 12, wherein the determination that the parameter associated with the invoice information or the shipping data satisfies the threshold is based on at least one of: a determination that a quantity of goods associated with the shipment of goods sent to the end user is not equal to a quantity of goods associated with the shipment of goods delivered to the end user, an elapsed time is greater than a threshold time, a quantity of disputed shipments exceeds a threshold quantity of shipments, the disputed payment amount exceeds a threshold dollar value, or a success rate associated with past disputed shipments is less than a threshold percentage.

14. The method of claim 11, wherein the method further comprises:
formatting the invoice information from the end user database and the shipping data into a pre-defined format; and
storing the invoice information and the shipping data in a user accessible database, wherein the determination whether to dispute the invoice amount occurs in response to storing the invoice information and the shipping data in the user accessible database.

15. The method of claim 11, wherein the method further comprises:
comparing the invoice ID with the shipping data to determine that the invoice information and the shipping data correspond to the shipment of goods, wherein the determination whether to dispute the invoice amount is further based on the determined correspondence.

16. The method of claim 11, wherein the method further comprises:
determining that a second parameter associated with the dispute message satisfies a second dispute threshold;
based on the determination that the second parameter satisfies the second dispute threshold, generating a second dispute message that indicates at least a second disputed payment amount, and a second dispute justification summary, wherein the second dispute justification summary includes text associated with the second disputed payment amount; and
transmitting the second dispute message to the end user.

17. The method of claim 16, wherein the method further comprises:
determining that the second parameter associated with the dispute message satisfies the second dispute threshold based on at least one of: an elapsed time since the dispute message was sent is greater than a time threshold, a quantity of disputed shipments is greater than a threshold number of shipments, the second disputed payment amount greater than a threshold dollar value, or a success rate associated with past disputed shipments is less than a threshold percentage.

18. The method of claim 11, wherein the shipping data comprises at least one of a purchase order, a receipt, a proof of delivery, or an invoice, and wherein the dispute message transmitted to the end user is configured to improve a recovery rate associated with the disputed payment amount.

19. The method of claim 11, wherein the indication that the invoice type is invalid further indicates that the shipment of goods is not open, short, or damaged (OS&D), and wherein the disputed payment amount is determined based at least on a comparison of the invoice amount to a quantity of goods delivered to the end user.

20. The method of claim 11, wherein the determination whether to generate the dispute message is further based on a trained artificial intelligence (AI) model, wherein the trained AI model is trained via training data, wherein the training data comprises historical invoice information, historical dispute messages, and historical shipping data.
